(19) United States
(12) Patent Application Publication
(10) Pub. No.: US 2026/0259398 A1
(43) Pub. Date: Sep. 3, 2026

(54) IMAGING OPTICAL SYSTEM AND IMAGE PICKUP APPARATUS

(71) Applicant: CANON KABUSHIKI KAISHA, Tokyo (JP)

(72) Inventor: Yuma KOBAYASHI, Tochigi (JP)

(21) Appl. No.: 19/467,974

(22) Filed: Feb. 3, 2026

(30) Foreign Application Priority Data
Feb. 7, 2025 (JP) 2025-018995

(51) Int. Cl. G02B 17/08

(52) U.S. Cl. CPC G02B 17/0856

(57) ABSTRACT

An imaging optical system includes at least one positive lens, at least one negative lens, a first transmissive reflective surface, and a second transmissive reflective surface disposed closer to an image plane than the first transmissive reflective surface.

### BACKGROUND

### Field of the Technology

The present disclosure relates to an imaging optical system and an image pickup apparatus.

### Description of the Related Art

Aberrations tend to increase in imaging optical systems with large apertures (i.e., small F-numbers). PCT International Patent Publication No. WO 2019/229849 discloses an imaging optical system having a large aperture.

### SUMMARY

An imaging optical system according to one aspect of the disclosure may include at least one positive lens, at least one negative lens, a first transmissive reflective surface, and a second transmissive reflective surface disposed closer to an image plane than the first transmissive reflective surface. The following inequality may be satisfied:

3Rt−6≤θ≤30Rt+20

where Rt is a telephoto ratio of the imaging optical system, and θ [°] is a half field angle of the imaging optical system. An image pickup apparatus having the above imaging optical system also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a conceptual diagram illustrating the trends in the characteristics of optical materials in a typical imaging optical system.

FIG. 2 is a conceptual diagram illustrating the trends in the characteristics of optical materials in an imaging optical system according to each example.

FIG. 3 is a schematic diagram illustrating an optical path of an imaging optical system according to each example.

FIG. 4 is a schematic diagram illustrating another optical path of an imaging optical system according to each example.

FIG. 5 is a sectional view of an imaging optical system according to Example 1.

FIG. 6 is an aberration diagram of the imaging optical system according to Example 1.

FIG. 7 is a sectional view of an imaging optical system according to Example 2.

FIG. 8 is an aberration diagram of the imaging optical system according to Example 2.

FIG. 9 is a sectional view of an imaging optical system according to Example 3.

FIG. 10 is an aberration diagram of the imaging optical system according to Example 3.

FIG. 11 is a sectional view of an imaging optical system according to Example 4.

FIG. 12 is an aberration diagram of the imaging optical system according to Example 4.

FIG. 13 is a sectional view of an imaging optical system according to Example 5.

FIG. 14 is an aberration diagram of the imaging optical system according to Example 5.

FIG. 15 is a sectional view of an imaging optical system according to Example 6.

FIG. 16 is an aberration diagram of the imaging optical system according to Example 6.

FIG. 17 is a sectional view of an imaging optical system according to Example 7.

FIG. 18 is an aberration diagram of the imaging optical system according to Example 7.

FIG. 19 is a sectional view of an imaging optical system according to Example 8.

FIG. 20 is an aberration diagram of the imaging optical system according to Example 8.

FIG. 21 is a sectional view of an imaging optical system according to Example 9.

FIG. 22 is an aberration diagram of the imaging optical system according to Example 9.

FIG. 23 is a sectional view of an imaging optical system according to Example 10.

FIG. 24 is an aberration diagram of the imaging optical system according to Example 10.

FIG. 25 is a sectional view of an imaging optical system according to Example 11.

FIG. 26 is an aberration diagram of the imaging optical system according to Example 11.

FIG. 27 is a sectional view of an imaging optical system according to Example 12.

FIG. 28 is an aberration diagram of the imaging optical system according to Example 12.

FIG. 29 is a sectional view of an imaging optical system according to Example 13.

FIG. 30 is an aberration diagram of the imaging optical system according to Example 13.

FIG. 31 is a sectional view of an imaging optical system according to Example 14.

FIG. 32 is an aberration diagram of the imaging optical system according to Example 14.

FIG. 33 is a sectional view of an imaging optical system according to Example 15.

FIG. 34 is an aberration diagram of the imaging optical system according to Example 15.

FIG. 35 is a sectional view of an imaging optical system according to Example 16.

FIG. 36 is an aberration diagram of the imaging optical system according to Example 16.

FIG. 37 is a sectional view of an imaging optical system according to Example 17.

FIGS. 38A and 38B are aberration diagrams of the imaging optical system according to Example 17.

FIG. 39 is a sectional view of an imaging optical system according to Example 18.

FIGS. 40A and 40B are aberration diagrams of the imaging optical system according to Example 18.

FIG. 41 is a sectional view of an imaging optical system according to Example 19.

FIG. 42 is an aberration diagram of the imaging optical system according to Example 19.

FIG. 43 is a sectional view of an imaging optical system according to Example 20.

FIG. 44 is an aberration diagram of the imaging optical system according to Example 20.

FIG. 45 is a sectional view of an imaging optical system according to Example 21.

FIG. 46 is an aberration diagram of the imaging optical system according to Example 21.

FIG. 47 is a sectional view of an imaging optical system according to Example 22.

FIG. 48 is an aberration diagram of the imaging optical system according to Example 22.

FIG. 49 is a schematic diagram of the image pickup apparatus having the imaging optical system according to any one of Examples 1 to 22.

### DESCRIPTION OF THE EMBODIMENTS

Referring now to the accompanying drawings, a detailed description will be given of examples according to the disclosure. Each of the embodiments of the present disclosure described below can be implemented solely or as a combination of a plurality of the embodiments or features thereof where necessary or where the combination of elements or features from individual embodiments in a single embodiment is beneficial.

Generally, an imaging optical system has a positive overall power. Thus, in a typical refractive optical system, in order to achieve both Petzval sum correction and chromatic aberration correction, a configuration may be adopted in which a positive lens has a high refractive index and low dispersion, and a negative lens has a low refractive index and high dispersion. As the depth of focus becomes shallow (i.e., as the aperture diameter of the optical system increases), stricter correction is required for the Petzval sum (image plane) and longitudinal chromatic aberration, which is a focus shift for each color. Thus, the above configuration is particularly required. However, in general, the refractive indices and dispersions of optical materials such as glass or resin tend to be positively correlated. Therefore, in such combinations, the difference in refractive index or Abbe number reduces, and the powers of individual lenses may be increased. In particular, a concave lens having a low refractive index tends to require a small radius of curvature on its concave surface, and such a concave surface tends to cause a large sagittal coma.

Although sagittal coma may be reduced by increasing the number of lenses used and reducing the burden of each lens, such an approach inevitably leads to increased system size and higher cost. Furthermore, prioritizing sagittal coma reduction may often result in insufficient chromatic aberration correction, particularly increasing longitudinal chromatic aberration.

Accordingly, each example adopts a polarization-reflective configuration, uses reflective surfaces, particularly concave mirrors, and provides an imaging optical system that has a reduced size, high performance, and a large aperture diameter.

Since a reflective surface exhibits a Petzval sum having the opposite sign to that of a refractive lens, the Petzval sums of a convex lens with positive power and a concave mirror with positive power may cancel each other. Thus, the concave lens having a small radius of curvature that would otherwise be required in a refractive system (dioptric system) to cancel the Petzval sum of the convex lens becomes unnecessary, enabling the reduction of sagittal coma. Moreover, the refractive optical system may include many positive lenses with low refractive indices that are difficult to use in refractive systems due to their large Petzval sums. As discussed above, refractive index and dispersion are generally positively correlated; thus, low-refractive-index materials exhibit low dispersion, which is effective for chromatic aberration correction. In combination with the fact that reflective surfaces themselves do not cause chromatic aberration, the use of reflective surfaces may facilitate effective reduction of chromatic aberration.

Many low-refractive-index materials exhibit strong anomalous dispersion. For example, when used in the visible region, not only the chromatic aberration between the C-line and the F-line but also the chromatic aberration at wavelengths shorter than the F-line can be easily reduced. Therefore, in the imaging optical system according to each example, the refractive index of the positive lens may be low and for the refractive index of the negative lens may be high.

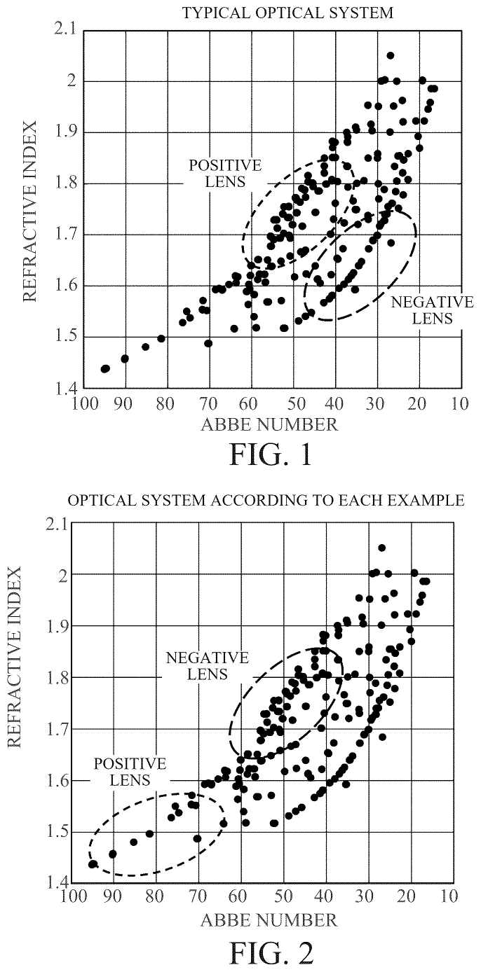

FIGS. 1 and 2 conceptually illustrate, on a glass map, the differences in refractive index and dispersion of lenses used in a typical imaging optical system and in the imaging optical systems according to each embodiment. FIGS. 1 and 2 are conceptual views, and in each example it is not necessarily required to use materials within the ranges illustrated in FIG. 2.

For these reasons, the imaging optical system according to each example may satisfy the following configurations and conditions.

The imaging optical system according to each example forms an optical image of an object on an image plane and is suitable for imaging in which an image sensor or photosensitive film is disposed on the image plane to obtain an image. The imaging optical system according to each example may include at least one lens with positive refractive power (positive lens), at least one lens with negative refractive power (negative lens), a first transmissive reflective surface, and a second transmissive reflective surface closer to the image plane than the first transmissive reflective surface. Refractive power is a reciprocal of the focal length of the lens. The imaging optical system according to each example may be a first-order imaging system that does not form an intermediate image (i.e., does not form an intermediate image plane). In a multi-stage (second or higher order) imaging system that forms an intermediate image, light rays that have once been imaged may be imaged again, resulting in a longer overall length. In addition, when light rays are condensed on an optical element, the optical element may get damaged depending on the intensity of the light rays and the optical elements used. However, the imaging optical system according to each example may be configured to form an intermediate image when necessary.

Let Np and vp be an average value of a refractive index at the d-line and an average value of an Abbe number based on the d-line of all positive lenses included in the imaging optical system according to each example. Let Nn and vn be an average value of a refractive index at the d-line and an average value of an Abbe number based on the d-line of all negative lenses included in the imaging optical system according to each example. Then, the imaging optical system according to each example may satisfy at least one of inequalities (1) and (2) below. The Abbe number vd based on the d-line is expressed as:

$$v d = ( N d - 1 ) / ( NF - N C )$$

where Nd, NF, and NC represent the refractive indices of the d-line (587.6 nm), F-line (486.1 nm), and C-line (656.3 nm) in the Fraunhofer, respectively.

When calculating the refractive-index and Abbe-number averages, a lens through which a light ray passes three times is counted only once.

$$0.06 \leq N n - N p \leq 0 \text{.50} \qquad ( 1 )$$

$$- 0.1 \; 00 \leq ( 1 / vn - 1 / vp ) / ( Nn - N p ) \leq 0.225 \qquad ( 2 )$$

Inequality (1) defines a proper range of a refractive-index difference between the positive lens and the negative lens. In a case where Nn-Np is lower than the lower limit value of inequality (1), as discussed above, the power of the concave lens becomes too strong, leading to an increase in sagittal coma. In addition, it becomes difficult to secure a proper Abbe-number difference, or low-dispersion materials become difficult to use, thereby increasing chromatic aberration. In a case where Nn-Np is higher than the upper limit value of inequality (1), the refractive lenses generate a Petzval sum that cannot be canceled by the reflective surface, resulting in a large deviation of the image plane from a plane.

However, certain lenses may be excluded when calculating Np, vp, Nn, and vn. More specifically, such lenses include those having an absolute value of the focal length that is at least ten times the focal length of the entire optical system, having the thickness on the optical axis of 300 μm or less, and having the thickness on the optical axis of 1/50 or less of the focal length of the entire system. Examples include a resin layer formed on a spherical glass substrate to form a hybrid or replica aspherical lens. Although the optical elements, such as a resin layer, are effective for correcting spherical aberration and the like, their contribution to the Petzval-sum correction or chromatic-aberration correction is limited; thus, they may be excluded from the calculations above.

The lower limit value of inequality (1) may be set to 0.065, 0.068, 0.070, 0.080, 0.090, or 0.100. The upper limit value may be set to 0.480, 0.470, 0.460, or 0.450.

Inequality (2) defines a proper range of a slope in the relationship between the Abbe numbers and refractive indices of the positive and negative lenses illustrated in FIG. 2. In a case where (1/vn−1/vp)/(Nn−Np) becomes higher than the upper limit value of inequality (2), the refractive index of the negative lens becomes too low relative to the positive lens, and it becomes difficult to take advantage of the reflective surface, resulting in overcorrection of the Petzval sum. In a case where (1/vn−1/vp)/(Nn−Np) becomes lower than the lower limit value of inequality (2), the dispersion of each lens increases, and chromatic aberration increases.

The lower limit value of inequality (2) may be set to −0.07, −0.05, −0.03, or 0. The upper limit value may be set to 0.20, 0.15, 0.13, 0.11, 0.10, 0.09, 0.08, or 0.070.

The imaging optical system according to each example may satisfy the following inequality (3):

$$3 R t - 6 \leq θ \leq 30 R t + 20 \qquad ( 3 )$$

where Rt is a telephoto ratio, which is a value obtained by dividing the focal length by the optical overall length of the imaging optical system, and 0 (degrees) is a half angle of view of the imaging optical system.

In a case where 0 becomes higher than the upper limit value of inequality (3), the optical overall length becomes too short relative to the angle of view, resulting in large incident angles of light rays on each optical surface including the transmissive reflective surfaces. As a result, due to the angular dependence of optical elements such as transmissive reflective elements and phase shifters, as well as antireflection coatings, their intended effects may not be sufficiently achieved, resulting in significant ghost and flare. In a case where 0 becomes lower than the lower limit value of inequality (3), the overall optical length increases. In this case, the size of the imaging optical system increases, and additional space becomes available to place numerous very weak-power lenses, which reduces the necessity of effectively utilizing the reflective surface.

The lower limit value of inequality (3) may be set to 3.2Rt−6, 3.3Rt−6, 3.4Rt−6, or 3.5Rt−6. The upper limit value may be set to 28Rt+20, 27Rt+20, 26Rt+20, or 25Rt+20.

The imaging optical system according to each example may satisfy the following inequality (4):

$$0 < \vert f / R1 \vert \leq 0.5 \qquad ( 4 )$$

where Rl is a radius of curvature of one of the first and second transmissive reflective surfaces that has a larger radius of curvature, and f is a focal length of the imaging optical system.

In a case where |f/Rl| is higher than the upper limit value of inequality (4), the two transmissive reflective surfaces will have strong curvature, increasing the sensitivity to decentering as reflective surfaces. In addition, strong curvature makes it more difficult to manufacture the transmissive reflective surfaces. As described later, at least one of the first and second transmissive reflective surfaces may be a polarization-selective transmissive reflective element such as a polarization beam splitter. Forming a polarization-selective transmissive reflective element on a curved surface is difficult and requires a special manufacturing process. In contrast, a surface close to a plane allows manufacture using a process similar to that used for commercially available flat-type polarization beam splitters.

The upper limit value of inequality (4) may be set to 0.4, 0.3, 0.26, 0.20, 0.15, or 0.1.

The imaging optical system according to each example may satisfy the following inequality (5):

$$0 < \vert Rs / f \vert \leq 20 \qquad ( 5 )$$

where Rs is a radius of curvature of one of the first and second transmissive reflective surfaces that has a smaller radius of curvature.

In a case where |Rs/f| becomes higher than the upper limit value of inequality (5), the reflective power of the transmissive reflective surface becomes too weak, thereby reducing the effects of Petzval-sum correction and chromatic-aberration correction achieved by the reflective surface.

The upper limit value of inequality (5) may be set to 18, 15, 12, or 10.

The imaging optical system according to each example may satisfy the following inequality (6):

$$1.43 \leq N p \leq 1.78 \qquad ( 6 )$$

In a case where Np becomes higher than the upper limit value, the Petzval sum of the positive lens becomes excessively small, making it difficult to balance with the Petzval sum of the reflective surface. Furthermore, the dispersion of the positive lens increases, and longitudinal chromatic aberration increases. In a case where Np becomes lower than the lower limit value, the refractive index of the positive lens becomes too low, requiring a small radius of curvature of the positive lens. As a result, the thickness of the positive lens increases, causing an increase in the size and weight of the imaging optical system or causing significant spherical aberration.

The lower limit value of inequality (6) may be set to 1.44, 1.45, 1.46, 1.47, or 1.48. The upper limit value may be set to 1.76, 1.75, 1.74, 1.73, or 1.72.

The imaging optical system of the embodiments may satisfy the following inequality (7):

$$1. 6 \leq N n \leq 2.1 \qquad ( 7 )$$

In a case where Nn becomes higher than the upper limit value of inequality (7), the dispersion of the negative lens becomes too large, making chromatic-aberration correction difficult. In particular, materials having a large partial dispersion ratio in the short-wavelength range would be used as the negative lens material, making correction of short-wavelength chromatic aberration difficult. In a case where Nn becomes lower than the lower limit value of inequality (7), the refractive index of the negative lens becomes too low, requiring a small radius of curvature of the negative lens. As a result, sagittal coma increases. Additionally, the negative Petzval sum of the negative lens becomes excessively large. The imaging optical system according to each example cancels the positive Petzval sum of the positive lens using the negative Petzval sum of the concave mirror and the negative Petzval sum of the negative lens; therefore, an excessively large negative Petzval sum of the negative lens would limit the magnitude of the negative Petzval sum achievable by the concave mirror. This means that the power of the concave reflective surface may be reduced, reducing the effect of the concave reflective surface.

The lower limit value of inequality (7) may be set to 1.62, 1.63, 1.64, or 1.65. The upper limit value may be set to 2.08, 2.06, 2.05, 2.04, or 2.03.

The imaging optical system according to each example may satisfy the following inequality (8):

$$40 \leq Nn \times vn \leq 125 \qquad ( 8 )$$

In a case where Nn×vn becomes higher than the upper limit value of inequality (8), the difference in Abbe numbers between the positive lens and the negative lens becomes small, making chromatic aberration difficult to correct. In a case where Nn×vn becomes lower than the lower limit value of inequality (8), the dispersion of the negative lens becomes excessively large, and it becomes difficult to balance with the dispersion of the positive lens, resulting in large chromatic aberration.

The lower limit value of inequality (8) may be set to 42, 46, 45, 48, or 50. The upper limit value of inequality (8) may be set to 120, 115, 110, or 105.

The imaging optical system according to each example may satisfy the following inequality (9):

$$0 < D 12 / f \leq 0.5 \qquad ( 9 )$$

where D12 is a distance along the optical axis between the first transmissive reflective surface and the second transmissive reflective surface.

The upper limit value of inequality (9) may be set to 0.45, 0.44, 0.43, 0.42, or 0.41.

In a case where D12 becomes higher than the upper limit value of inequality (9), the distance between the transmissive reflective surfaces becomes too long. Although aberrations can be favorably corrected when many lenses are disposed between these surfaces, stray light generated between these lens surfaces and the transmissive reflective surfaces becomes stronger. In a case where the number of lenses between the transmissive reflective surfaces is small, it becomes difficult to place a sufficient number of lenses in the imaging optical system as a whole.

In the imaging optical system according to each example, the following inequality (10) may be satisfied:

$$0.2 \leq \vert Rns / f \vert \leq 5. \qquad ( 10 )$$

where Rns is the smallest radius of curvature among the refractive surfaces having negative refractive power, excluding cemented surfaces.

In a case where |Rns/f| becomes higher than the upper limit value of inequality (10), sagittal coma caused by the concave refractive surface becomes large. In a case where |Rns/f| becomes lower than the lower limit value of inequality (10), the negative power of the refractive surface becomes too weak relative to the entire imaging optical system, and it becomes impossible to cancel various aberrations such as longitudinal chromatic aberration generated by the positive lenses.

The lower limit value of inequality (10) may be set to 0.22, 0.25, 0.28, or 0.3. The upper limit value may be set to 4.5, 4.0, 3.5, or 3.2.

In the imaging optical system according to each example, the number of positive lenses in the optical path may be equal to or greater than the number of negative lenses. The number of lenses herein is counted such that, for example, a lens through which a light ray passes three times is counted as three lenses. The lenses referred to herein do not include reflective surfaces themselves or plane plates. As described above, the optical system according to each example may use low-refractive-index positive lenses and high-refractive-index negative lenses. For the same refractive power, a low-refractive-index lens generates spherical aberration more easily than a high-refractive-index lens; therefore, the number of positive lenses may be increased to reduce the refractive power of each lens. Conversely, the number of negative lenses having high refractive index can be reduced. Reducing the number of negative lenses also contributes to reducing sagittal coma caused by concave lenses. In a retrofocus-type super-wide-angle optical system, it may be effective to place many negative lenses on the object side of the aperture stop to reduce aberrations of extremely large off-axis light rays. However, for optical systems having a half angle of view of approximately 40° or less, the number of positive lenses may be greater than the number of negative lenses.

The imaging optical system according to each example may include a lens disposed closer to the object than the aperture stop. The “lens” here does not include a plane plate (an optical element having extremely low optical power, such as one having a focal length at least 70 times the focal length of the overall system). Due to this configuration, aberrations can be canceled between lenses located before and after the aperture stop, which is effective for correcting lateral chromatic aberration and distortion.

In the imaging optical system according to each example, the number of interfaces between air and a material having a refractive index of 1.4 or higher, located between the first transmissive reflective surface and the second transmissive reflective surface, may be two or fewer. A surface coating of 5 μm or less formed on another material is not included in this “material.” This configuration can suppress stray light generated by multiple reflections on the transmissive reflective surfaces and on the interfaces.

The imaging optical system according to each example may include a phase shifter between the first transmissive reflective surface and the second transmissive reflective surface. Due to this configuration, incident light can be efficiently emitted toward the image side to form a bright optical image while suppressing stray light. In this case, light incident from the object side passes through the first transmissive reflective surface and the phase shifter in this order, and is reflected by the second transmissive reflective surface. The light reflected by the second transmissive reflective surface passes again through the phase shifter, is reflected by the first transmissive reflective surface, passes through the phase shifter once more, and then reaches the image plane after passing through the second transmissive reflective surface.

The transmittance and reflectance of the first and second transmissive reflective surfaces may not be 50%. For randomly polarized light, the ratio between the transmittance and reflectance may be in the range of 1:3 to 3:1. Random polarization refers to light having Stokes parameters S0=1, S1=S2=S3=0. The first and second transmissive reflective surfaces may absorb part of the incident light. A lens may be formed or cemented to either or both sides of each transmissive reflective surface.

A phase shifter such as a quarter-wave plate (QWP) may be used. The QWP may be a birefringent polymer film or a liquid crystal alignment layer. Examples include “WA-140” manufactured by Nippon Kayaku Co., Ltd., and “PureAce WR” manufactured by Teijin Limited. When the operating wavelength band is wide, a so-called broadband waveplate exhibiting inverse dispersion characteristics may be used.

A phase shifter formed by laminating such polymer films or liquid-crystal alignment layers may also be used. Properly laminating these layers can provide a phase difference close to one quarter of the wavelength over a wide wavelength range. To accommodate broadband operation, a type in which chromatic compensation is performed by two birefringent layers may be used. For example, an “achromatic waveplate” such as model AQWP10M-580 (for use in the visible range) manufactured by Thorlabs Japan Inc. may be used.

“Polarcor” manufactured by ColorLink Japan Co., Ltd. may also be used. In addition to the above, an inorganic waveplate manufactured by Dexerials Corporation may be used as the QWP. Furthermore, a waveplate produced by orienting atoms or molecules using polarized irradiation to impart birefringence may also be used. Examples include the “ALR Series” manufactured by Osaka Organic Chemical Industry Ltd., and “HPOM” manufactured by Hayashi Telempu Corporation. The former is a two-layer structure in which an alignment layer and a birefringence-generating layer are separated, and the latter is based on bulk photoalignment. Using such materials can provide a phase shifter as a coating, making it easier to obtain a phase shifter with higher surface accuracy than polymer films.

A broadband type may also be used by combining a QWP and a half-wave plate (HWP), arranging their slow axes or fast axes at proper angles. A two-layer device is referred to as an HQ type, and a three-layer device is referred to as a Pancharatnam type. For example, “Polarcor” manufactured by ColorLink Japan Co., Ltd., corresponds to the Pancharatnam type. Typically, the Pancharatnam type combines two HWPs and one QWP, or one HWP and two approximately 0.3-wave plates, and either configuration may be used. When the HQ type or the Pancharatnam type is used, the characteristics of each individual layer may be favorable across the operating wavelength band. The better the characteristics of the individual layers are, the more favorable the overall laminated characteristics become. To further broaden the wavelength band or improve performance, a structure with additional layers may be used. Examples include “APSAW-5,” “APSAW-5-Wide,” “APSAW-5-Precise,” and “APSAW-7” manufactured by Astropribor, and “SB-RETAX-5L-1/4λ” manufactured by Rukeo Co., Ltd.

The QWP may be bonded to and disposed on the first transmissive reflective surface or the second transmissive reflective surface. Alternatively, the QWP may be disposed separately from these transmissive reflective surfaces. For example, the QWP film itself may be inserted into the optical path, or the film may be bonded to a glass substrate which is then inserted into the optical path. A lens may be formed or cemented on either or both sides of the QWP. For example, using wafer-level optics may provide a lens on one or both sides of an inorganic waveplate serving as a substrate.

A 45° optical rotator, such as a Faraday rotator, may be used instead of a QWP. Using an optical rotator can improve the light-use efficiency as described later.

The function of the phase shifter may also be integrated with a transmissive reflective surface. For example, a cholesteric liquid-crystal layer reflects specified circularly polarized light and transmits the other specified circularly polarized light. This can be regarded as a structure in which a QWP is integrated with a transmissive reflective surface, such as a polarization beam splitter (PBS), and such a structure may be used.

The imaging optical system according to each example may be coaxial. Thereby, the manufacture of each optical element can be simplified and the assembly and adjustment processes can be facilitated. However, the optical effective areas (regions through which imaging light passes) and the outer shapes of lenses or transmissive reflective surfaces do not necessarily have to be rotationally symmetric; they may be rectangular and may include notches or orientation flats indicating the axis orientation of a polarization element.

As described above, at least one of the first and second transmissive reflective surfaces may be a polarization-selective transmissive reflective element. Examples of polarization-selective transmissive reflective elements include “WGF” manufactured by Asahi Kasei Corporation, “IQP-E” manufactured by 3M Company, and “ProFlux” manufactured by Moxtek, Inc. A transmissive reflective surface that is not polarization-selective transmissive reflective surface may be configured as a half-mirror or a cholesteric liquid-crystal layer.

Both the first and second transmissive reflective surfaces may include polarization-selective transmissive reflective elements. In this case, by placing a 45° optical rotator (e.g., a Faraday rotator) between the two transmissive reflective surfaces can suppress a reduction in light amount. This configuration may use the first quarter-wave plate (QWP1), the second quarter-wave plate (QWP2), and the linear polarizer (POL) described below.

Adopting the following configuration in the imaging optical system according to each example can reduce ghost light (unnecessary light) originating from an optical path without being reflected even once at a transmissive reflective surface while suppressing light amount drop along the normal imaging light path. Ghost light from the optical path that reaches the image plane after being reflected two or more times at each transmissive reflective surface can also be reduced. The following configuration explains a case in which one transmissive reflective surface uses a polarization-selective transmissive reflective element, and the other transmissive reflective surface uses a half-mirror.

As the polarization-selective transmissive reflective element, an optical element may be used in which a grid is formed on the reflective surface of a lens during molding of the lens, and a metal or dielectric is deposited, printed, or formed by lithography on the grid.

### Polarization-Utilization Configuration 1

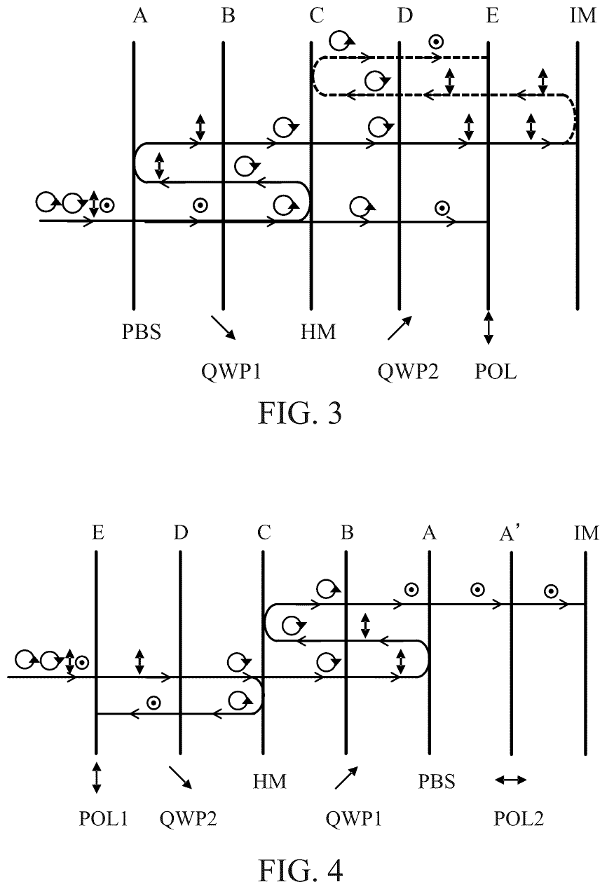

FIG. 3 illustrates the utilization of polarization in an imaging optical system that includes, from the object side (left side of the figure) toward the image (imaging surface IM) side, a polarization-selective transmissive reflective element PBS: A as a first transmissive reflective surface, a first quarter-wave plate QWP1: B, a half-mirror HM: C as a second transmissive reflective surface, a second quarter-wave plate QWP2: D, and a linear polarizer POL: E.

The PBS is configured to reflect linearly polarized light having the same polarization direction as that of the linearly polarized light that has transmitted through the linear polarizer POL, and to transmit linearly polarized light having a polarization direction orthogonal to it. The PBS is a wire-grid polarizer or a reflection-type polarizer of a retardation-film laminated type. The wire-grid forming surface or the retardation-film surface of the PBS functions as the transmissive reflective surface. The wire-grid polarizer does not necessarily require metal wires aligned in parallel; any optical element having thin metal or dielectric layers disposed at predetermined intervals and functioning as a transmissive reflective element may be used, such as elements produced by depositing aligned metal or dielectric layers.

The QWP1 and QWP2 are arranged such that their slow axes are tilted by 45° relative to the transmission axis of the POL. The QWP1 and QWP2 may be arranged such that their slow axes differ by 90°. Due to this arrangement, when light passes through the QWP1 and QWP2, the wavelength-dispersion characteristics of the waveplates cancel each other.

The HM is a half-mirror formed, for example, by a dielectric multilayer film or metallic deposition, and functions as a transmissive reflective surface. The POL is an absorptive linear polarizer, for example.

Among the light incident on the imaging optical system from the object side, the linearly polarized light that has transmitted through the PBS is converted into circularly polarized light by the QWP1. This circularly polarized light enters the HM, where a part is reflected and becomes circularly polarized light in the reverse rotation direction, which returns to the QWP1. The returned circularly polarized light is converted by the QWP1 into linearly polarized light whose polarization direction is orthogonal to that of the linearly polarized light that has previously transmitted through the PBS. This linearly polarized light returns to the PBS and is reflected.

The circularly polarized light that has transmitted through the HM is converted by the QWP2 into linearly polarized light having the same polarization direction as that of the linearly polarized light that has transmitted through the PBS, and this light is absorbed by the POL.

The linearly polarized light reflected by the PBS is converted by the QWP1 into circularly polarized light, which enters the HM. A part of the circularly polarized light incident on the HM transmits through it and enters the QWP2, where it is converted into linearly polarized light having the same polarization direction as that of the linearly polarized light reflected by the PBS. The linearly polarized light emitted from the QWP2 enters the POL. Since the polarization direction of the incident linearly polarized light coincides with the transmission axis of the POL, most of the light passes through the POL and reaches the IM.

Due to the polarization-utilization configuration described above, among the light incident on the imaging optical system, only the light that passes through the PBS, is reflected by the HM, is reflected by the PBS, and transmits through the HM reaches the IM.

In a case where a cholesteric liquid crystal is used instead of the HM as the second transmissive reflective surface, the cholesteric liquid crystal may be disposed such that it strongly reflects the circularly polarized light incident during the first reflection. Thereby, the light amount in the normal light path can be increased while ghost light is reduced.

In an image sensor, such as a CCD sensor and a CMOS sensor, the reflectance of the imaging surface is generally high. Thus, light reflected by the IM passes again through the POL and is converted into circularly polarized light by the QWP2. Thereafter, the circularly polarized light is reflected by the HM, becomes circularly polarized light of in the reverse rotation direction, and enters the QWP2 again. The circularly polarized light in the reverse rotation direction is converted by the QWP2 into linearly polarized light whose polarization direction is orthogonal to that of the linearly polarized light that has transmitted through the POL just before. This linearly polarized light enters the POL. Since the polarization direction is orthogonal to the transmission axis of the POL, most of the light is absorbed by the POL.

Thus, light reflected by the IM and HM is almost completely removed, and ghost and flare are less noticeable. To obtain such a reflection-reduction effect, no optical low-pass filter using birefringence may be present between IM and POL. This is because an optical low-pass filter would shift the polarization state from the linearly polarized light state.

In this configuration, a quarter-wave plate may be disposed between the PBS and the object. In such a case, the quarter-wave plate is disposed so that its fast axis or slow axis forms an angle of 45° relative to the transmission axis of the PBS.

Thereby, the polarization state is pseudo-randomized, and even when the light incident from the object is linearly polarized light, imaging can be performed regardless of the polarization direction. A depolarizer may be used instead of the quarter-wave plate. As the depolarizer, “Cosmoshine SRF” manufactured by Toyobo Co., Ltd. may be used. Cosmoshine SRF is a film having a large birefringence of approximately 10,000 nm, and the use of such a film is expected to suppress color non-uniformity caused by the wavelength and angle characteristics of a quarter-wave plate.

### Polarization-Utilization Configuration 2

FIG. 4 illustrates the utilization of polarization in an imaging optical system that includes, in order from the object side toward the image (imaging surface IM) side, a first linear polarizer POL1:E, a second quarter-wave plate QWP2: D, a half-mirror HM: C serving as a second transmissive reflective surface, a first quarter-wave plate QWP1: B, and a polarization-selective transmissive reflective element PBS: A as a first transmissive reflective surface. The arrangement, optical-axis orientation, and configurations of the polarization-selective transmissive reflective element, the quarter-wave plate, and the linear polarizer are similar to those in Polarization-Utilization Configuration 1.

Of the light incident on the imaging optical system from the object side, the linearly polarized light that has transmitted through the POL1 is converted into circularly polarized light by the QWP2. The circularly polarized light enters the HM, a part of which is reflected, becomes circularly polarized light in the reverse rotation direction, and returns to the QWP2. The circularly polarized light in the reverse rotation direction returning to the QWP2 is converted by the QWP2 into linearly polarized light whose polarization direction is orthogonal to that of the linearly polarized light that has previously transmitted through the POL1, and the linearly polarized light is absorbed by the POL1.

On the other hand, the circularly polarized light that has transmitted through the HM is converted by the QWP1 into linearly polarized light having the same polarization direction as that of the linearly polarized light that has previously transmitted through the POL1, and enters the PBS. The linearly polarized light is reflected by the PBS and returns to the QWP1. The linearly polarized light returning to the QWP1 is converted into circularly polarized light, and a part of the circularly polarized light is reflected by the HM, becomes circularly polarized light in the reverse rotation direction, and enters the QWP1 again. The circularly polarized light in the reverse rotation direction entering QWP1 is converted into linearly polarized light whose polarization direction is orthogonal to that of the linearly polarized light previously reflected by the PBS. This linearly polarized light transmits through the PBS and reaches the IM.

Due to the polarization-utilization configuration described above, only the light that transmits through the HM, is reflected by the PBS, is reflected by the HM, and transmits through PBS reaches IM.

In this configuration, a second linear polarizer POL2: A′ may be disposed between the PBS and the IM. At this time, the direction of the transmission axis of the POL2 is matched with that of the PBS. Thereby, light that would be ghost or flare can be absorbed, because light is reflected by the IM, is reflected by the PBS, and again enters the IM.

In this configuration, a quarter-wave plate may be disposed between the POL1 and the object. In this case, the quarter-wave plate is disposed so that its fast axis or slow axis forms an angle of 45° relative to the transmission axis of the POL1. This enables imaging regardless of the polarization direction even when the incident light from the object is linearly polarized light. Instead of the quarter-wave plate, the depolarizer described in Polarization-Utilization Configuration 1 may be used.

In the description of the above two polarization-utilization configurations, the expressions “orthogonal,” “same (parallel),” and “45°” have been used. These expressions do not indicate exact angles of 90°, 0°, and 45°, respectively. Any angle within ±5°, ±2°, or ±1° of these angles may be used.

However, these angles depend on the characteristics of the QWP1 and QWP2. If the characteristics of the quarter-wave plates were ideal, and the characteristic change relative to the wavelength and incident angle is sufficiently small, then, for example, in the configuration of FIG. 3, the relative angles between A and B and between D and E may be any angle. In reality, it is difficult to achieve ideal characteristics of the quarter-wave plate, so the above angles may be used, but the angles may be determined such that, in consideration of characteristic errors and manufacturing variations of the quarter-wave plates, the intensity and color of ghost light are not noticeable.

In the above two polarization-utilization configurations, the same quarter-wave plate may be used for the QWP1 and the QWP2. If the quarter-wave plates were ideal (i.e., strictly providing a quarter-wavelength phase shift for all wavelengths used and incident angles), different quarter-wave plates may be used. In the above two polarization-utilization configurations, the phases imparted by the QWP1 and the QWP2 when light passes through them cancel each other, allowing only specific light rays to be emitted toward the image side. That is, light that is reflected once at the PBS and once at the HM is emitted toward the image side, while light that has never been reflected at all and light reflected twice are absorbed by the linear polarizer. If the characteristics of the QWP1 and the QWP2 differ from one another, unintended light is emitted toward the image side, increasing ghost and flare.

In the above two polarization-utilization configurations, an image sensor including an optical low-pass filter may be used. In such a case, the relative angle between the transmission axis of the linear polarizer closest to the image plane and the fast axis of the birefringent plate closest to the object among the birefringent plates constituting the optical low-pass filter may be 45° or 135°. Thereby, a similar low-pass effect to that of an ordinary refractive optical system with almost no polarization dependence may be acquired. Furthermore, a quarter-wave plate may be disposed on the image side of the linear polarizer closest to the image plane. In this case, the relative angle between the fast axis of the quarter-wave plate and the transmission axis of the linear polarizer closest to the image plane may be 45° or 135°. Thereby, a low-pass effect similar to that of a typical optical system may be acquired by emitting circularly polarized light toward the image sensor. Pseudo-randomly polarized light of the emitted light may be formed by placing a plastic molded lens having large birefringence on the image side of the linear polarizer closest to the image plane, thereby providing a low-pass effect similar to that of a conventional optical system.

In the two polarization-utilization configurations described above, the polarization-selective transmissive reflective element, the quarter-wave plate, and the linear polarizer may be circular or rectangular. In a case where film-like polarizing elements primarily made of polymer materials are used, sufficient surface precision may be secured by bonding them to, for example, a glass or resin plate, as described above. By bonding a large-format film to a glass or resin plate and then cutting out a rectangular or other shape from it, material waste can be reduced. In the two polarization-utilization configurations described above, the azimuth relationship between the polarizing elements is important, as described above. Using rectangular polarizing elements makes it easier to ensure the outer shape and element orientation (fast axis/slow axis, transmission axis/absorption axis, transmission axis/reflection axis) of each component can simplify or eliminate the need for azimuth adjustment. Instead of being perfectly rectangular, polarizing elements may have a notch or orientation flat for azimuth alignment in a part of the polarizing element.

In the imaging optical system according to each example, either a resin material or a glass material may be used as the lens material. However, a lens disposed between the first transmissive reflective surface and the second transmissive reflective surface may be made of a low-birefringence material.

A description will now be given of imaging optical systems according to Examples 1 to 22. After the description of Example 22, numerical examples 1 to 22 corresponding to Examples 1 to 22, respectively, will be presented.

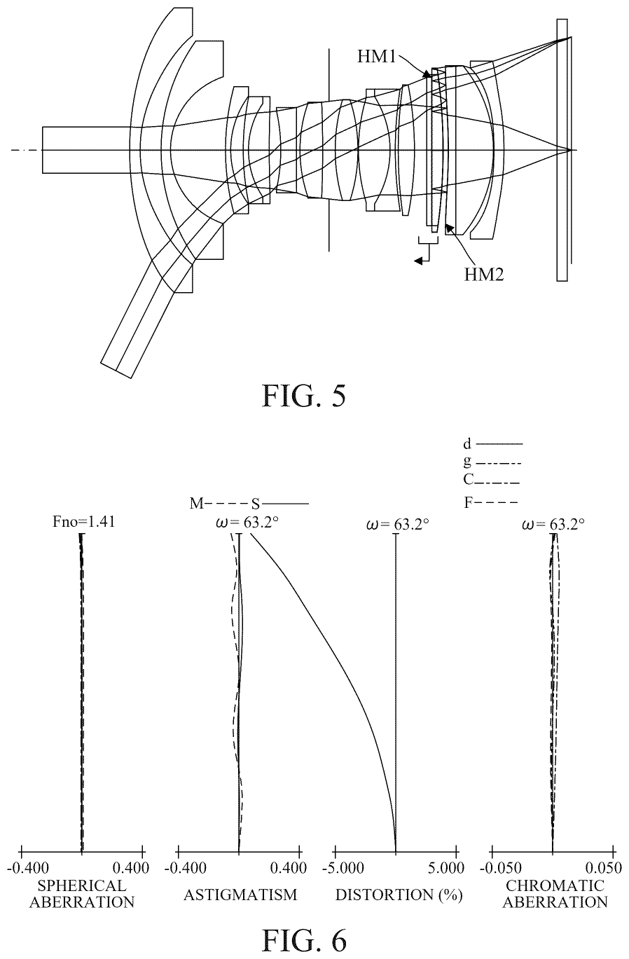

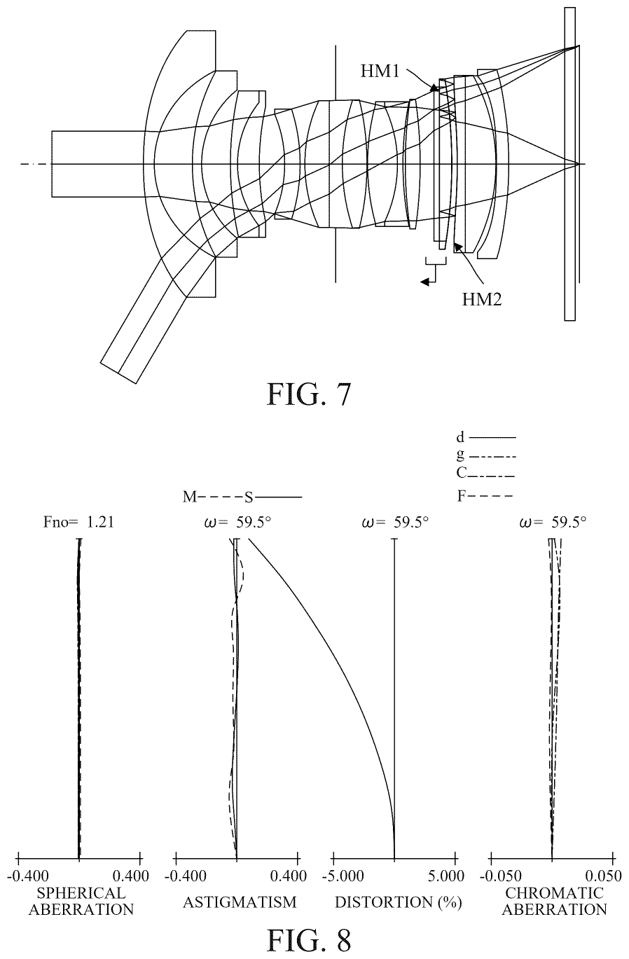

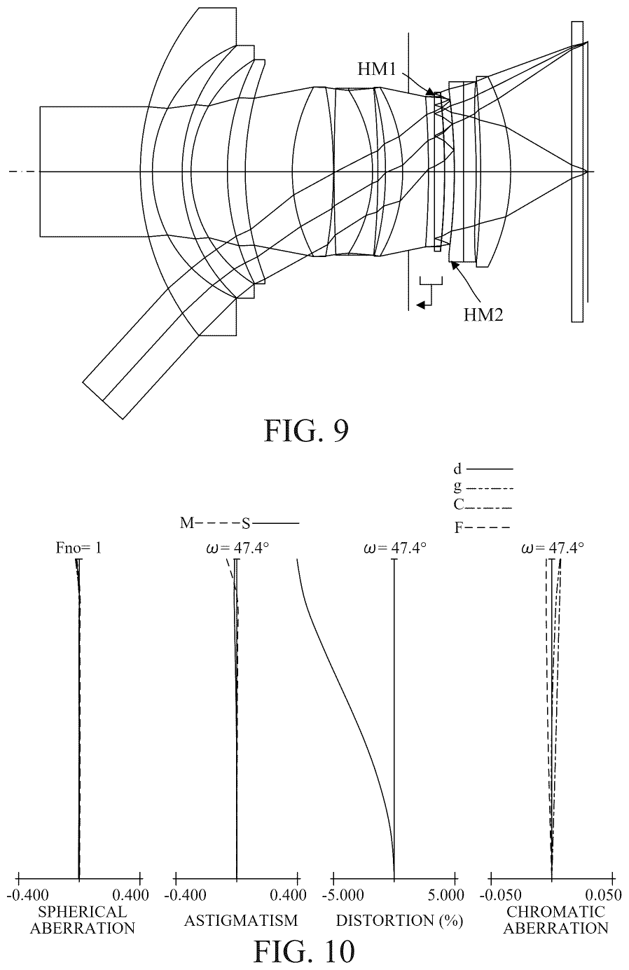

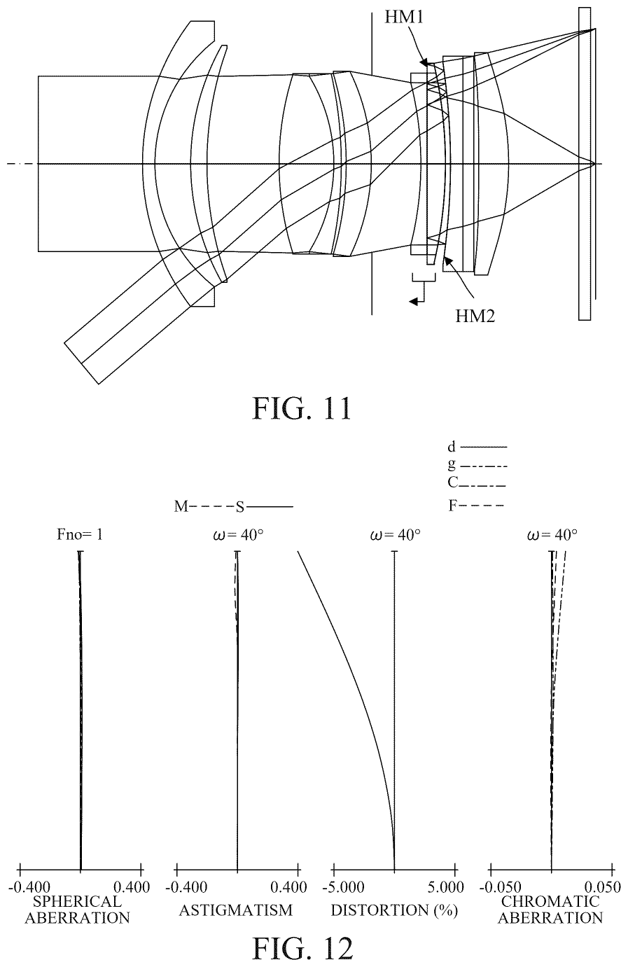

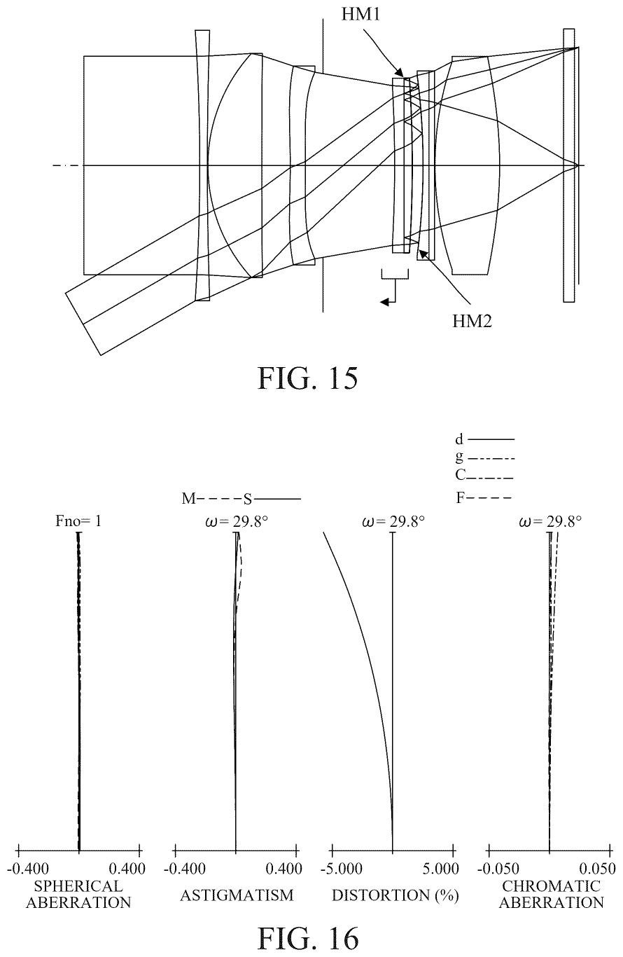

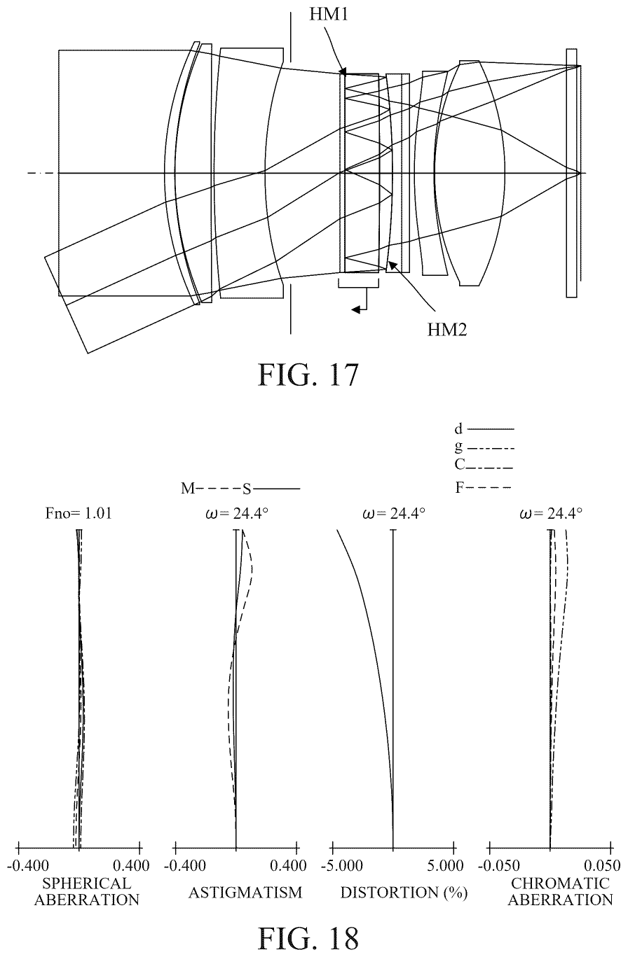

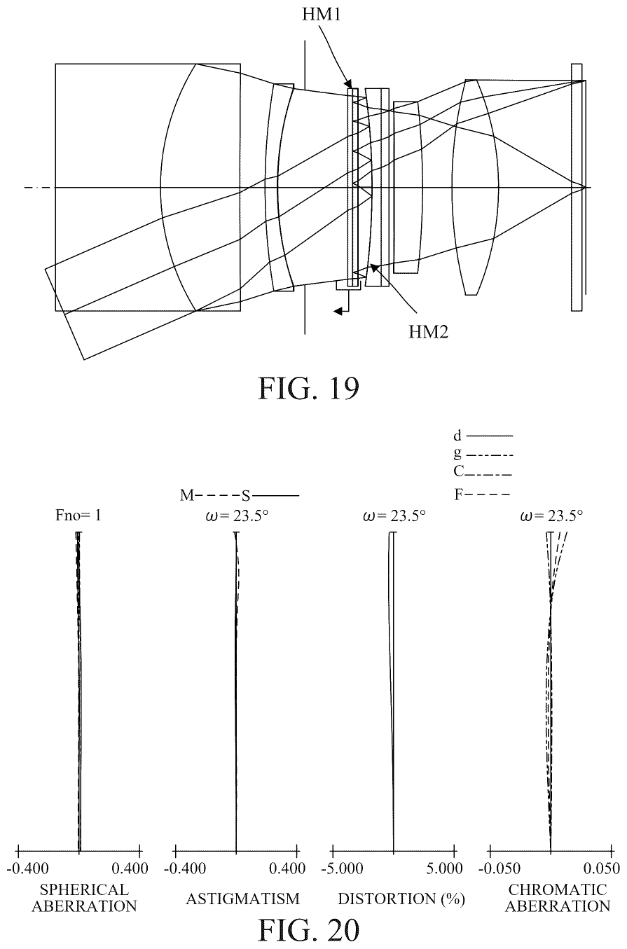

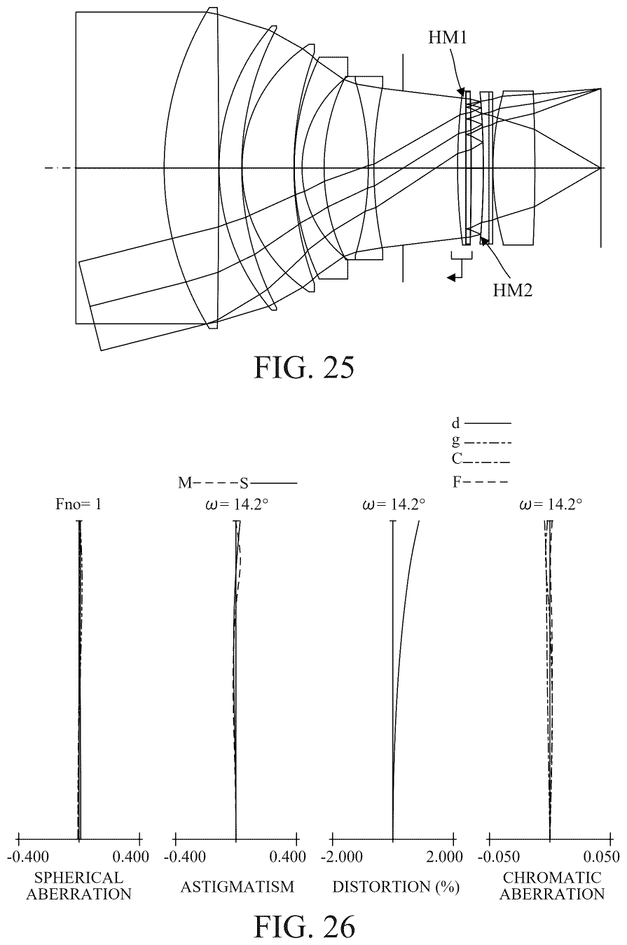

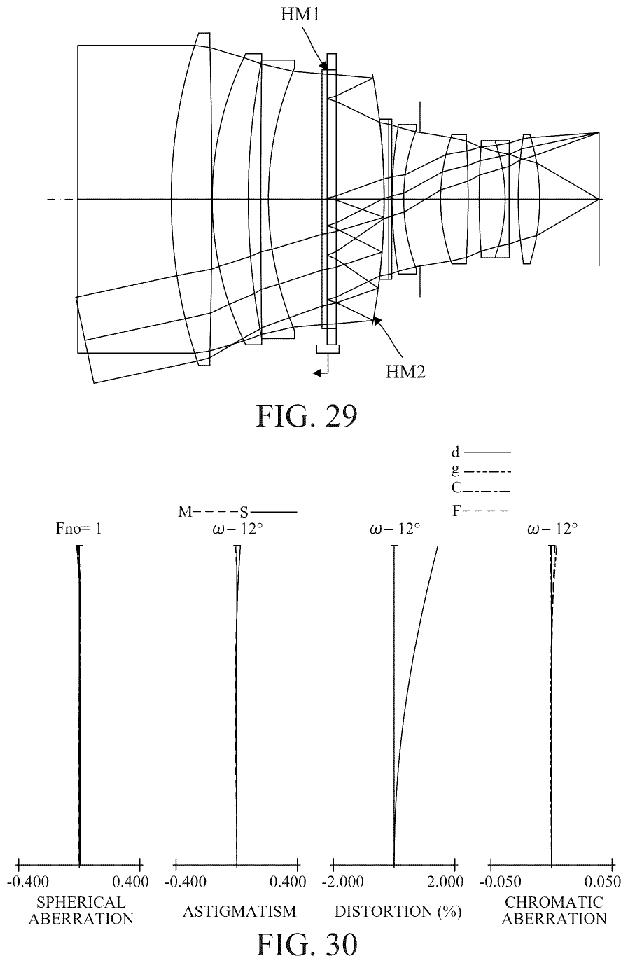

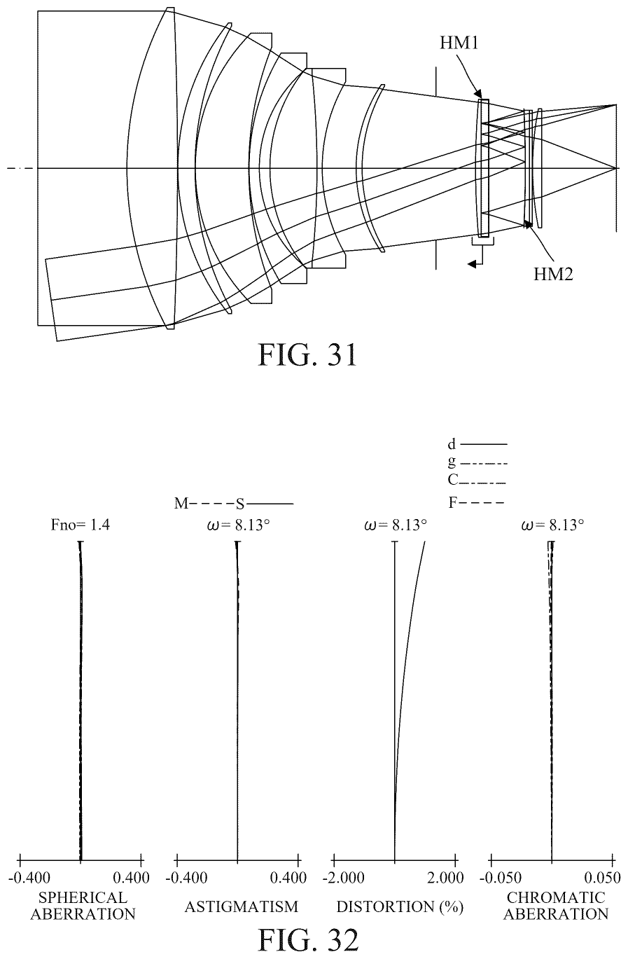

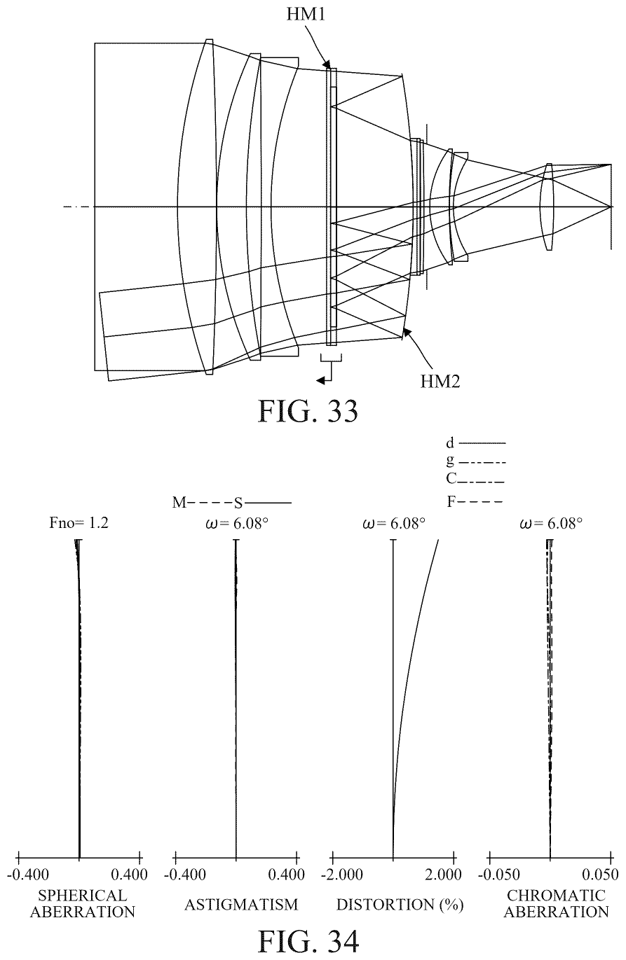

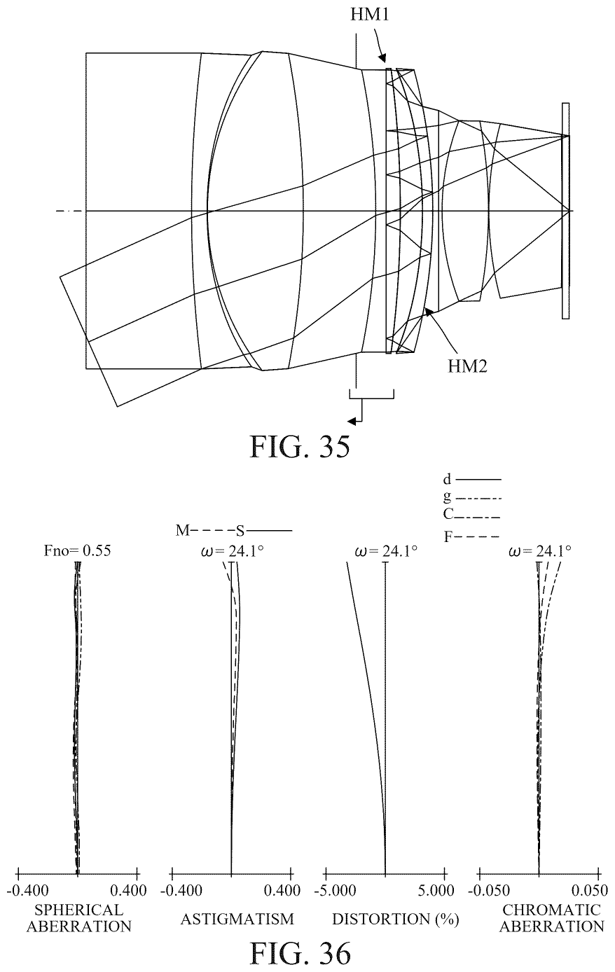

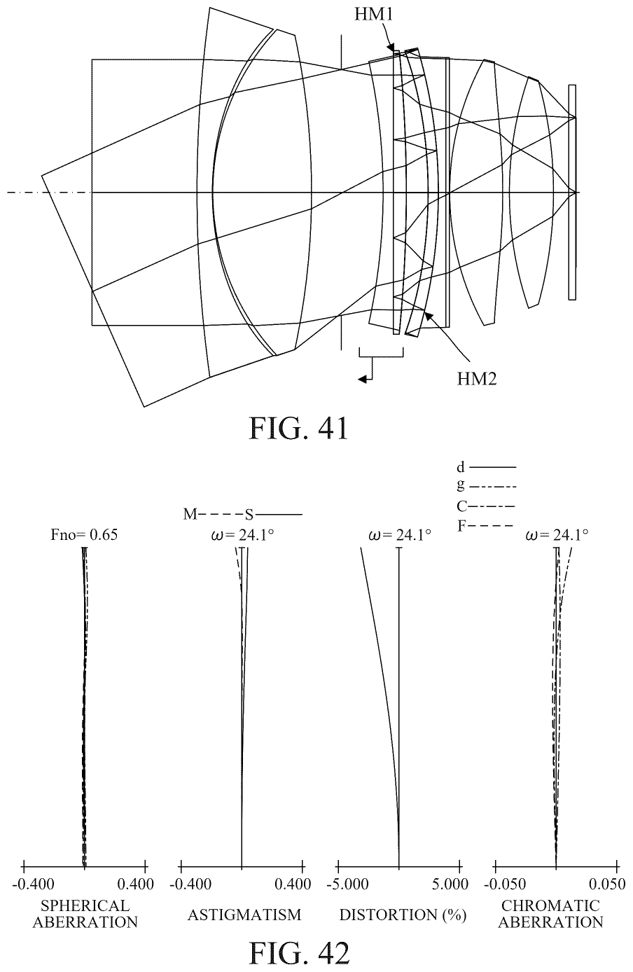

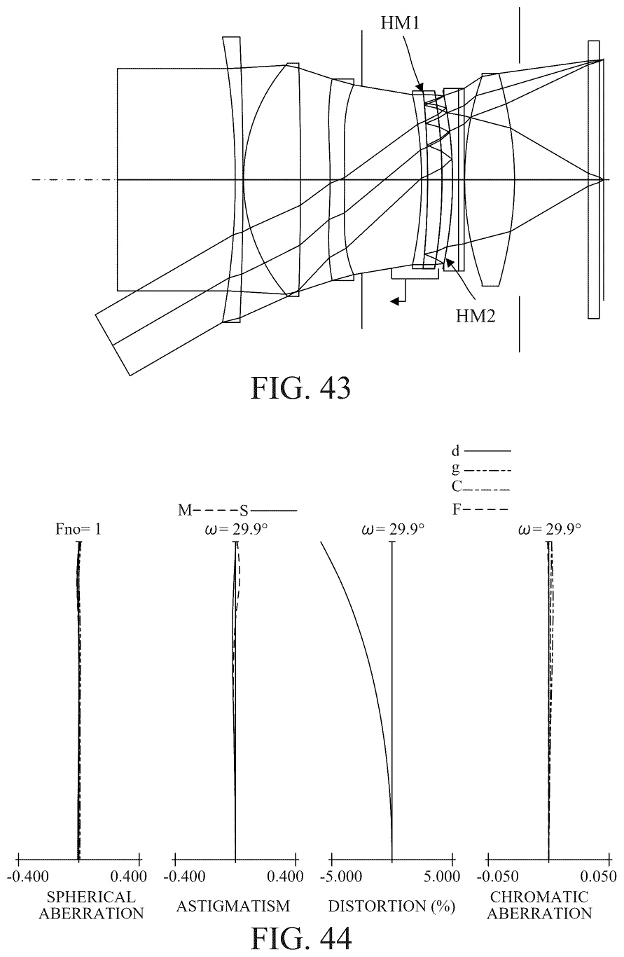

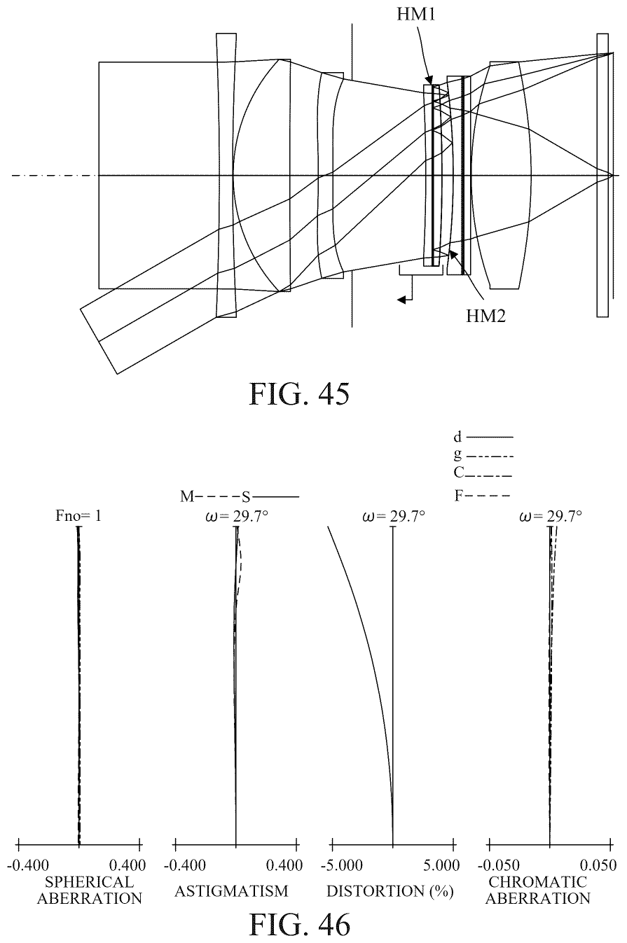

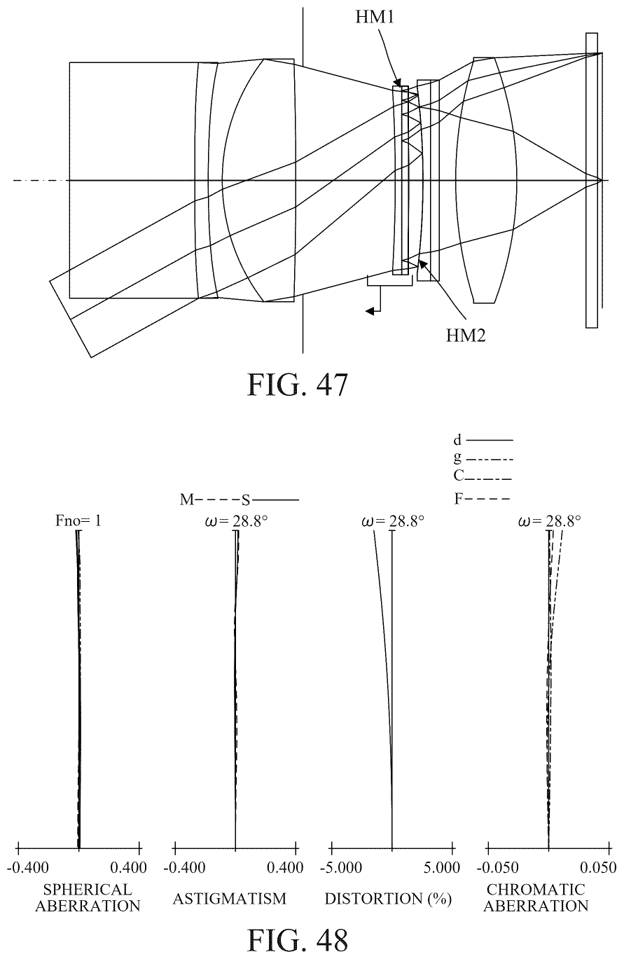

Each of the imaging optical systems whose cross-sections are illustrated in FIGS. 5, 7, 9, 11, 13, 15, 17, 19, 21, 23, 25, 27, 29, 31, 33, 35, 37, 39, 41, 43, 45, and 47, corresponding to Examples 1 to 22, respectively, includes a plurality of positive and negative lenses, the first transmissive reflective surface HM1, the second transmissive reflective surface HM2, and an aperture stop. The vertically extending straight line above and below the imaging optical system represents the aperture stop. A sensor protection glass in the form of a parallel plate is provided on the front side of the image sensor.

In each drawing, a lens with an arrow mark indicates a lens that moves in an arrow direction during focusing. This is similarly applicable to the other examples.

In the imaging optical system according to Example 8, the image-side surface of the second lens from the object side and the object-side surface of the second lens from the image side are each formed as hybrid aspherical surfaces by molding a thin resin layer on the surface. In the imaging optical system according to Example 17, the image-side surface of the fourth lens from the object side is a hybrid aspherical surface. As discussed above, these thin resin layers are excluded from the calculations of Np, Nn, vp, and vn.

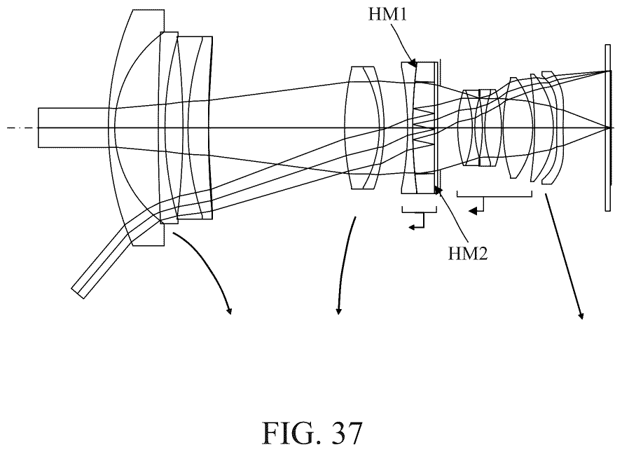

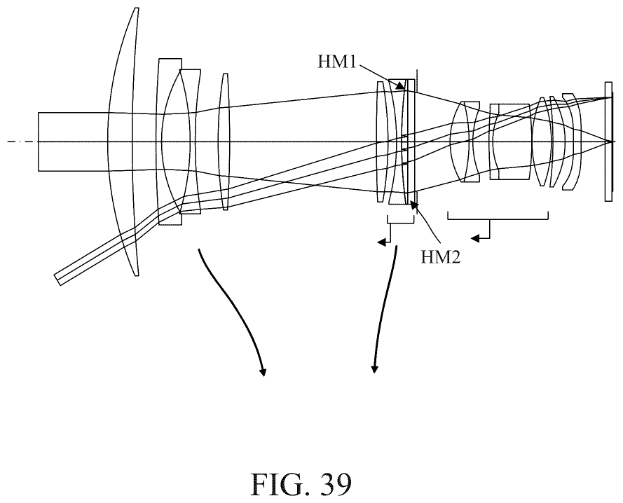

The imaging optical systems according to Examples 17 and 18 are zoom lenses. FIGS. 37 and 39 illustrate the imaging optical systems at the wide-angle end. Below the lens units that move during zooming, the moving loci of the respective lens units from the wide-angle end to the telephoto end are illustrated. In a zoom lens, a lens unit refers to one or more lenses that move during zooming, and each distance between adjacent lens units during zooming changes.

In each figure, the thicknesses of polarization elements such as a quarter-wave plate, a polarization-selective transmissive reflective element, and a linear polarizer, are generally omitted. This is because these elements are sufficiently thin, and their plane shapes or the shapes of their front and back surfaces are approximately the same meniscus shapes, and therefore have little influence on optical design through ray tracing. The imaging optical system according to Example 21 is obtained by incorporating layers corresponding to the thicknesses of the polarization elements into the imaging optical system according to Example 6. These are approximately equivalent in cross-sectional shape, overall length, and the aberrations described later.

In many embodiments, a plane surface is provided immediately on the image side of the transmissive reflective surface, and a quarter-wave plate or a linear polarizer may be disposed on this plane surface. A polarization element may also be given a curved surface shape.

The imaging optical system according to Example 19 secures the aperture diameter such that substantially no vignetting occurs even at an off-axis position, and is substantially telecentric on the image-side side.

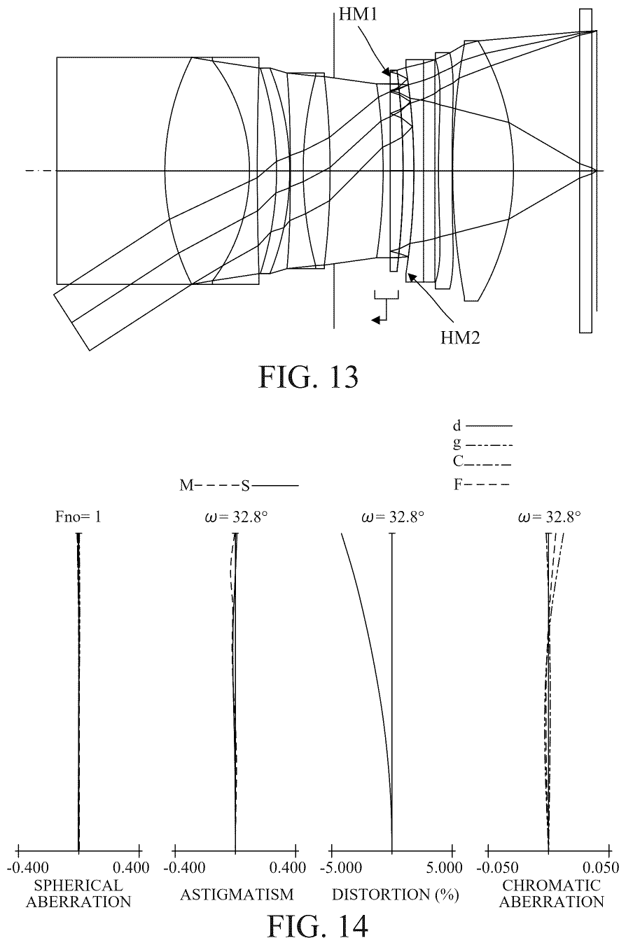

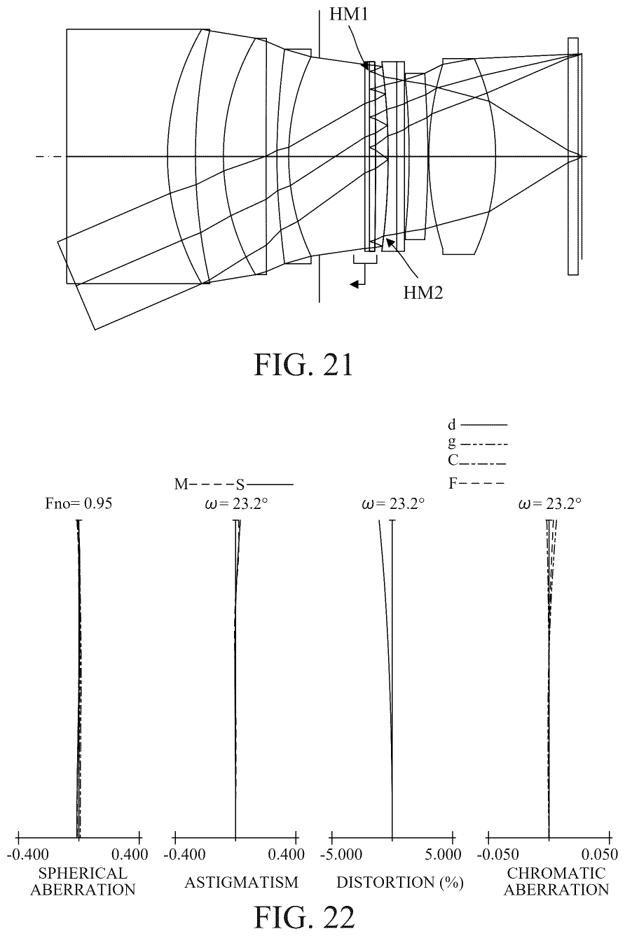

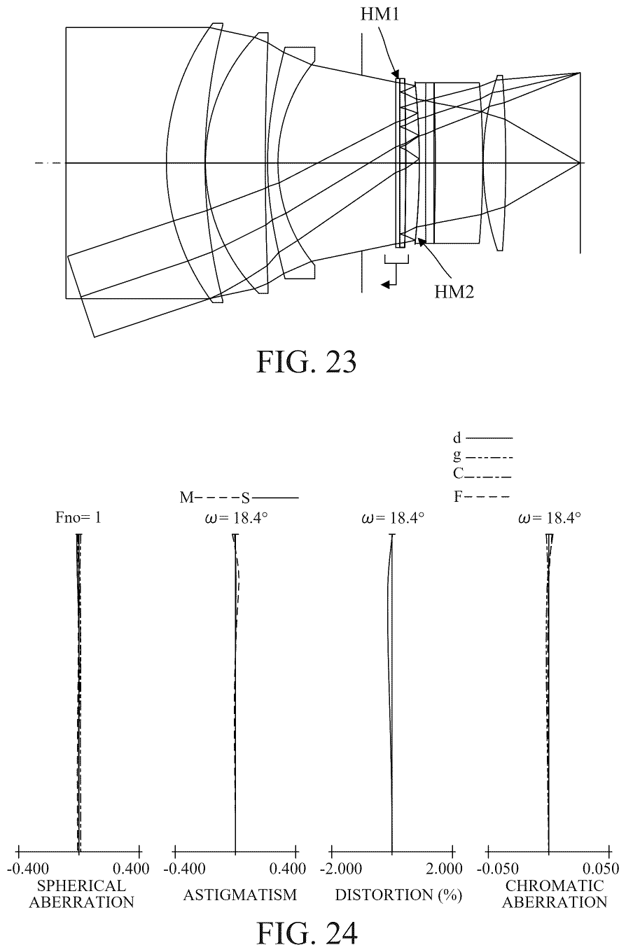

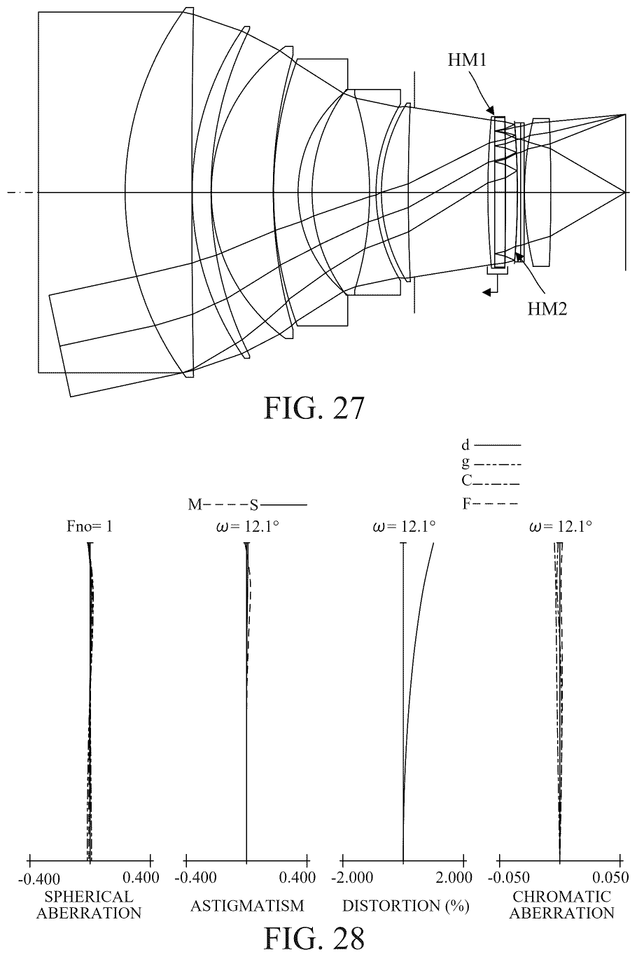

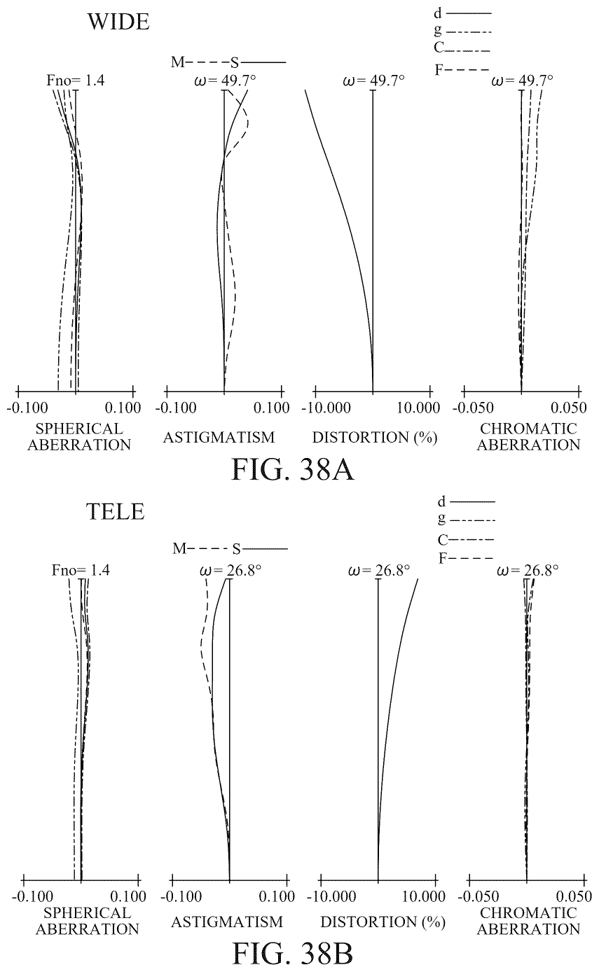

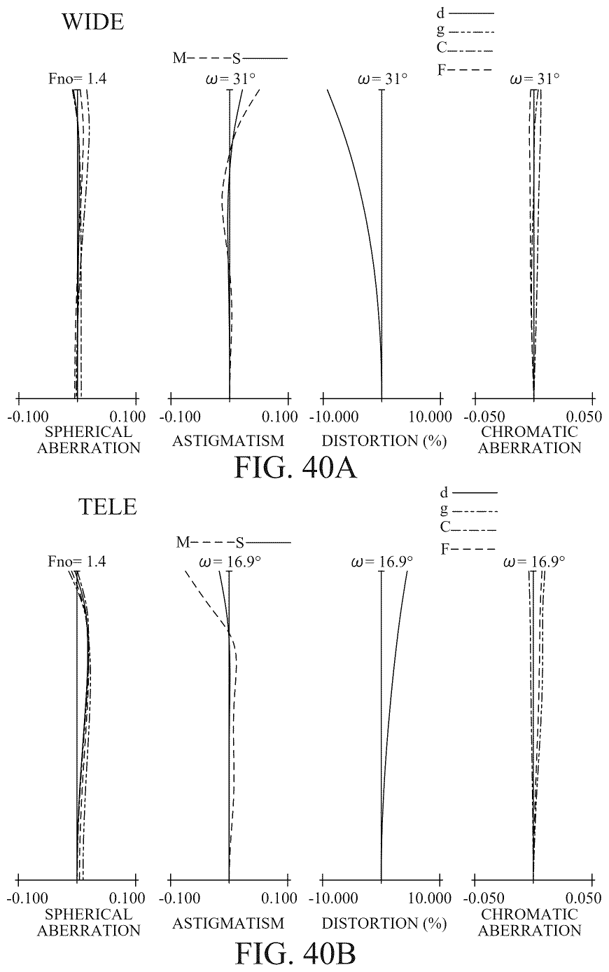

FIGS. 6, 8, 10, 12, 14, 16, 18, 20, 22, 24, 26, 28, 30, 32, 34, 36, 38A, 38B, 40A, 40B, 42, 44, 46, and 48 illustrate the longitudinal aberrations (spherical aberration, astigmatism, distortion, and chromatic aberration) of the imaging optical system according to Example 1 in an in-focus state (on an object) at infinity. In the spherical aberration diagrams, “Fno” denotes an F-number; a solid line represents a spherical aberration amount at the d-line (wavelength 587.6 nm), an alternate long and two short dashes line represents a spherical aberration amount for at the g-line (wavelength 435.8 nm), an alternate long and short dash line represents a spherical aberration amount at the C-line (wavelength 656.3 nm), and a long-broken line represents a spherical aberration amount at the F-line (wavelength 486.1 nm). In the astigmatism diagrams, a solid line “S” represents an astigmatism amount on the sagittal image plane, and a broken line “M” represents an astigmatism amount on the meridional image plane. The distortion diagram illustrates a distortion amount at the d-line. The chromatic aberration diagram illustrates lateral chromatic aberration amounts at the g-line, C-line, and F-line. ω represents a half angle of view) (°. FIGS. 38A and 40A illustrate the longitudinal aberrations at the wide-angle end and (b) of the imaging optical systems according to numerical examples 17 and 18, respectively. FIGS. 38B and 40B illustrate the longitudinal aberrations at the telephoto end of the imaging optical systems according to numerical examples 17 and 18, respectively.

A description will be given of numerical examples 1 to 22. In each numerical example, a surface number i represents the order of a surface counted from the object side. r represents a radius of curvature of an i-th surface counted from the object side (mm), d represents a lens thickness or air gap (mm) between i-th and (i+1)-th surfaces, and nd represents a refractive index at the d-line of an optical material between i-th and (i+1)-th surfaces. vd represents an Abbe number at the d-line of an optical material between i-th and (i+1)-th surfaces, as defined above.

An asterisk “*” attached to a surface number indicates that the surface has an aspherical shape. The aspherical shape is expressed by the following equation:

$$x ( h ) = \frac{( \frac{{h}^{2}}{R} )}{1 + \sqrt{\{ 1 - ( 1 + K ) {( \frac{h}{R} )}^{2} \}}} + {A}_{4} {h}^{4} + + {A}_{6} {h}^{6} + {A}_{8} {h}^{8} + {A}_{10} {h}^{10} + …$$

where x is a displacement amount in the optical-axis direction from a surface vertex at a height h from the optical axis, R is a paraxial radius of curvature, K is a conic constant, and Ai (i=2, 4, 6, 8, . . . ) are the aspheric coefficients of respective orders.

“e±M” for the conic constant and the aspheric coefficients means×10^{±M}. For conditions relating to aspherical surfaces, the value of R is used as the radius of curvature.

Various data also include a focal length (mm), an F-number, an image height (mm), and a back focus BF. Back focus is a distance on the optical axis from the lens surface (final surface) closest to the image plane in the imaging optical system to the paraxial image plane, expressed as an air-equivalent length. Adding the back focus to the distance on the optical axis from the lens surface (front surface) closest to the object in the imaging optical system to the final surface gives the overall optical length.

### Numerical Example 1

UNIT: mm
SURFACE DATA

| Surface No. | r | d | nd | νd |
|---|---|---|---|---|
| 1* | 64.650 | 2.00 | 1.64000 | 60.1 |
| 2* | 26.097 | 4.03 | | |
| 3 | 35.904 | 1.80 | 1.43875 | 94.7 |
| 4 | 14.762 | 10.60 | | |
| 5 | 45.820 | 1.00 | 1.43875 | 94.7 |
| 6 | 17.211 | 2.41 | | |
| 7 | 49.172 | 1.00 | 1.49700 | 81.5 |
| 8 | 15.751 | 4.00 | 1.67270 | 32.1 |
| 9 | 241.941 | 2.22 | | |
| 10 | −34.415 | 3.00 | 1.88300 | 40.8 |
| 11 | 840.178 | 0.70 | | |
| 12 | 26.965 | 4.36 | 1.51633 | 64.1 |
| 13 | −232.027 | 1.20 | | |
| 14 (SP) | ∞ | 1.21 | | |
| 15 | 33.345 | 4.38 | 1.43875 | 94.7 |
| 16 | −30.890 | 0.10 | | |
| 17 | 34.176 | 6.08 | 1.43875 | 94.7 |
| 18 | −18.998 | 1.00 | 2.00069 | 25.5 |
| 19 | 72.143 | 0.57 | | |
| 20 | 86.327 | 3.13 | 1.98612 | 16.5 |
| 21 | −64.092 | 2.35 | | |
| 22 | ∞ | 1.00 | 1.51633 | 64.1 |
| 23 | ∞ | 2.16 | 1.49700 | 81.5 |
| 24 | −106.284 | 1.00 | | |
| 25* | −115.812 | −1.00 | | |
| 26 | −106.284 | −2.16 | 1.49700 | 81.5 |
| 27 | ∞ | 2.16 | | |
| 28 | −106.284 | 1.00 | | |
| 29* | −115.812 | 1.43 | 2.00069 | 25.5 |
| 30 | ∞ | 7.26 | 1.43875 | 94.7 |
| 31 | −25.118 | 0.10 | | |
| 32* | −71.103 | 1.93 | 1.82080 | 42.7 |
| 33* | −61.989 | 10.19 | | |
| 34 | ∞ | 2.00 | 1.51633 | 64.1 |
| 35 | ∞ | 0.80 | | |
| Image Plane | ∞ | | | |

ASPHERIC DATA
1st Surface
K = 0.00000e+00 A 4 = 9.52473e−06 A 6 = −2.85605e−08 A 8 = 5.28543e−11
A10 = −4.61064e−14 A12 = 2.03360e−17
2nd Surface
K = 0.00000e+00 A 4 = 1.47113e−06 A 6 = −4.37035e−08 A 8 = 5.11565e−11
25th Surface
K = 0.00000e+00 A 4 = 7.12542e−06 A 6 = 5.99711e−09 A 8 = −2.17890e−11
A10 = 9.57625e−14
29th Surface
K = 0.00000e+00 A 4 = 7.12542e−06 A 6 = 5.99711e−09 A 8 = −2.17890e−11
A10 = 9.57625e−14
32nd Surface
K = 0.00000e+00 A 4 = −7.62007e−05 A 6 = 3.27016e−07 A 8 = −9.60416e−10
A10 = 5.46201e−13
33rd Surface
K = 0.00000e+00 A 4 = −3.90397e−05 A 6 = 3.65881e−07 A 8 = −1.02636e−09
A10 = 8.71529e−13

VARIOUS DATA

| | |
|---|---|
| Focal Length | 12.43 |
| Fno | 1.41 |
| Image Height | 21.64 |
| BF | 0.80 |
| d35 | 0.80 |

### Numerical Example 2

UNIT: mm
SURFACE DATA

| Surface No. | r | d | nd | νd |
|---|---|---|---|---|
| 1* | 61.102 | 2.00 | 1.58913 | 61.1 |
| 2* | 18.414 | 6.98 | | |
| 3 | 35.431 | 1.70 | 1.43875 | 94.7 |
| 4 | 17.271 | 5.28 | | |
| 5 | 60.429 | 1.30 | 1.43875 | 94.7 |
| 6 | 17.952 | 4.00 | 1.62200 | 30.7 |
| 7 | 47.997 | 4.66 | | |
| 8 | −23.408 | 2.83 | 1.91082 | 35.3 |
| 9 | −32.708 | 0.87 | | |
| 10 | 27.216 | 4.46 | 1.51633 | 64.1 |
| 11 | ∞ | 1.20 | | |
| 12 (SP) | ∞ | 1.21 | | |
| 13 | 36.989 | 4.53 | 1.43875 | 94.7 |
| 14 | −49.315 | 0.10 | | |
| 15 | 41.283 | 5.49 | 1.43875 | 94.7 |
| 16 | −24.547 | 1.00 | 2.00069 | 25.5 |
| 17 | 58.210 | 0.43 | | |
| 18 | 81.099 | 2.73 | 1.98612 | 16.5 |
| 19 | −81.439 | 2.53 | | |
| 20 | ∞ | 1.00 | 1.51633 | 64.1 |
| 21 | ∞ | 2.27 | 1.43875 | 94.7 |
| 22 | −95.502 | 1.00 | | |
| 23* | −108.199 | −1.00 | | |
| 24 | −95.502 | −2.27 | 1.43875 | 94.7 |
| 25 | ∞ | 2.27 | | |
| 26 | −95.502 | 1.00 | | |
| 27* | −108.199 | 1.50 | 2.00069 | 25.5 |
| 28 | ∞ | 5.60 | 1.43875 | 94.7 |
| 29 | −33.085 | 0.10 | | |
| 30* | −114.534 | 2.26 | 1.88202 | 37.2 |
| 31* | −79.242 | 10.28 | | |
| 32 | ∞ | 1.90 | 1.51633 | 64.1 |
| 33 | ∞ | 0.80 | | |
| Image Plane | ∞ | | | |

ASPHERIC DATA
1st Surface
K = 0.00000e+00 A 4 = 2.24515e−05 A 6 = −8.30532e−08 A 8 = 2.00354e−10
A10 = −2.47637e−13 A12 = 1.33311e−16
2nd Surface
K = 0.00000e+00 A 4 = 1.24129e−05 A 6 = 2.60775e−08 A 8 = −8.03271e−10
A10 = 3.29955e−12 A12 = −4.87762e−15
23rd Surface
K = 0.00000e+00 A 4 = 7.03926e−06 A 6 = 5.74120e−09 A 8 = −1.46618e−11
A10 = 9.18153e−14
27th Surface
K = 0.00000e+00 A 4 = 7.03926e−06 A 6 = 5.74120e−09 A 8 = −1.46618e−11
A10 = 9.18153e−14
30th Surface
K = 0.00000e+00 A 4 = −4.48759e−05 A 6 = 1.44576e−07 A 8 = −4.84029e−10
A10 = 2.54474e−13
31st Surface
K = 0.00000e+00 A 4 = −2.08820e−05 A 6 = 1.79676e−07 A 8 = −5.72713e−10
A10 = 5.47097e−13

VARIOUS DATA

| | |
|---|---|
| Focal Length | 14.50 |
| Fno | 1.21 |
| Image Height | 21.64 |
| BF | 0.80 |
| d33 | 0.80 |

### Numerical Example 3

UNIT: mm
SURFACE DATA

| Surface No. | r | d | nd | νd |
|---|---|---|---|---|
| 1 | 42.669 | 2.00 | 1.49700 | 81.5 |
| 2 | 22.744 | 5.00 | | |
| 3 | 28.653 | 1.50 | 1.69680 | 55.5 |
| 4 | 21.744 | 6.09 | | |
| 5 | 40.117 | 3.00 | 1.94594 | 18.0 |
| 6 | 50.151 | 7.88 | | |
| 7 | 29.515 | 6.91 | 1.43875 | 94.7 |
| 8 | −76.068 | 0.10 | | |
| 9 | 310.203 | 6.45 | 1.51633 | 64.1 |
| 10 | −24.937 | 0.90 | 2.05090 | 26.9 |
| 11 | −136.718 | 1.28 | | |
| 12 | −52.125 | 2.87 | 1.86966 | 20.0 |
| 13 | −27.880 | 1.00 | | |
| 14 (SP) | ∞ | 3.33 | | |
| 15 | −156.685 | 0.99 | 1.95375 | 32.3 |
| 16 | ∞ | 1.71 | 1.49700 | 81.5 |
| 17 | −124.037 | 1.64 | | |
| 18* | −92.427 | −1.64 | | |
| 19 | −124.037 | −1.71 | 1.49700 | 81.5 |
| 20 | ∞ | 1.71 | | |
| 21 | −124.037 | 1.64 | | |
| 22* | −92.427 | 1.54 | 1.85025 | 30.1 |
| 23 | ∞ | 2.10 | 1.55332 | 71.7 |
| 24* | −112.299 | 0.75 | | |
| 25 | −161.515 | 5.03 | 1.49700 | 81.5 |
| 26 | −34.825 | 10.24 | | |
| 27 | ∞ | 1.90 | 1.51633 | 64.1 |
| 28 | ∞ | 0.80 | | |
| Image Plane | ∞ | | | |

ASPHERIC DATA
18th Surface
K = 0.00000e+00 A 4 = 2.32615e−06 A 6 = 1.17228e−09 A 8 = 1.95210e−11
22nd Surface
K = 0.00000e+00 A 4 = 2.32615e−06 A 6 = 1.17228e−09 A 8 = 1.95210e−11
24th Surface
K = 0.00000e+00 A 4 = 1.87771e−05

VARIOUS DATA

| | |
|---|---|
| Focal Length | 21.61 |
| Fno | 1.00 |
| Image Height | 21.64 |
| BF | 0.80 |
| d28 | 0.80 |

### Numerical Example 4

UNIT: mm
SURFACE DATA

| Surface No. | r | d | nd | νd |
|---|---|---|---|---|
| 1 | 37.405 | 2.00 | 1.59282 | 68.6 |
| 2 | 24.936 | 5.76 | | |
| 3 | 38.207 | 2.62 | 1.91082 | 35.3 |
| 4 | 54.390 | 11.63 | | |
| 5 | 46.921 | 8.82 | 1.43875 | 94.7 |
| 6 | −26.753 | 1.20 | 2.00100 | 29.1 |
| 7 | −64.280 | 0.79 | | |
| 8 | −51.199 | 4.04 | 1.86966 | 20.0 |
| 9 | −33.453 | 0.10 | | |
| 10 (SP) | ∞ | 7.89 | | |
| 11 | −52.532 | 1.00 | 1.63930 | 44.9 |
| 12 | ∞ | 2.96 | 1.48749 | 70.2 |
| 13 | −69.499 | 0.82 | | |
| 14* | −100.005 | −0.82 | | |
| 15 | −69.499 | −2.96 | 1.48749 | 70.2 |
| 16 | ∞ | 2.96 | | |
| 17 | −69.499 | 0.82 | | |
| 18* | −100.005 | 2.00 | 1.95150 | 29.8 |
| 19 | ∞ | 1.75 | 1.51633 | 64.1 |
| 20 | ∞ | 0.77 | | |
| 21* | −13766.260 | 4.85 | 1.49710 | 81.6 |
| 22* | −43.581 | 11.30 | | |
| 23 | ∞ | 1.90 | 1.51633 | 64.1 |
| 24 | ∞ | 0.80 | | |
| Image Plane | ∞ | | | |

ASPHERIC DATA
14th Surface
K = 0.00000e+00 A 4 = 1.38858e−06 A 6 = −2.24822e−10 A 8 = 6.55128e−12
A10 = −1.17268e−14
18th Surface
K = 0.00000e+00 A 4 = 1.38858e−06 A 6 = −2.24822e−10 A 8 = 6.55128e−12
A10 = −1.17268e−14
21st Surface
K = 0.00000e+00 A 4 = −9.83057e−06 A 6 = −5.21152e−09 A 8 = 4.41622e−11
22nd Surface
K = 0.00000e+00 A 4 = 1.72858e−06 A 6 = −8.01864e−09 A 8 = 5.09686e−1

VARIOUS DATA

| | |
|---|---|
| Focal Length | 28.00 |
| Fno | 1.00 |
| Image Height | 21.64 |
| BF | 0.80 |
| d24 | 0.80 |

### Numerical Example 5

UNIT: mm
SURFACE DATA

| Surface No. | r | d | nd | νd |
|---|---|---|---|---|
| 1 | 38.754 | 13.16 | 1.51742 | 52.4 |
| 2 | −27.849 | 1.20 | 1.54072 | 47.2 |
| 3 | 457.998 | 3.01 | | |
| 4 | −50.870 | 2.04 | 1.80809 | 22.8 |
| 5 | −42.453 | 0.10 | | |
| 6* | −369.803 | 2.00 | 1.85400 | 40.4 |
| 7 | 56.462 | 4.18 | 1.43875 | 94.7 |
| 8 | −118.794 | 0.61 | | |
| 9 (SP) | ∞ | 7.64 | | |
| 10 | −88.326 | 1.10 | 1.77250 | 49.6 |
| 11 | ∞ | 2.00 | 1.56732 | 42.8 |
| 12 | −125.810 | 1.68 | | |
| 13 | −102.886 | −1.68 | | |
| 14 | −125.810 | −2.00 | 1.56732 | 42.8 |
| 15 | ∞ | 2.00 | | |
| 16 | −125.810 | 1.68 | | |
| 17 | −102.886 | 1.50 | 2.00100 | 29.1 |
| 18 | ∞ | 1.75 | 1.51633 | 64.1 |
| 19 | ∞ | 0.58 | | |
| 20* | 184.787 | 2.10 | 1.51633 | 64.1 |
| 21* | 468.816 | 0.10 | | |
| 22 | 105.746 | 9.45 | 1.53775 | 74.7 |
| 23 | −39.259 | 10.27 | | |
| 24 | ∞ | 1.90 | 1.51633 | 64.1 |
| 25 | ∞ | 0.80 | | |
| Image Plane | ∞ | | | |

ASPHERIC DATA
6th Surface
K = 0.00000e+00 A 4 = −3.95497e−06 A 6 = −1.10319e−09 A 8 = −4.75265e−14
A10 = −1.87315e−15
20th Surface
K = 0.00000e+00 A 4 = −4.40453e−07 A 6 = −5.28181e−08 A 8 = 1.68563e−11
21st Surface
K = 0.00000e+00 A 4 = 8.44176e−06 A 6 = −5.96413e−08 A 8 = 5.14173e−11
A10 = −4.79778e−14 A12 = 7.75287e−17

VARIOUS DATA

| | |
|---|---|
| Focal Length | 35.00 |
| Fno | 1.00 |
| Image Height | 21.64 |
| BF | 0.80 |
| d25 | 0.80 |

### Numerical Example 6

UNIT: mm
SURFACE DATA

| Surface No. | r | d | nd | νd |
|---|---|---|---|---|
| 1 | −366.904 | 1.40 | 1.72916 | 54.7 |
| 2 | 708.065 | 0.10 | | |
| 3 | 30.208 | 9.96 | 1.43875 | 94.7 |
| 4 | 2358.874 | 5.24 | | |
| 5* | −177.527 | 2.79 | 1.58913 | 61.1 |
| 6* | −550.125 | 3.28 | | |
| 7 (SP) | ∞ | 13.21 | | |
| 8 | −260.300 | 1.73 | 1.83481 | 42.7 |
| 9 | ∞ | 1.53 | 1.48749 | 70.2 |
| 10 | −241.236 | 1.99 | | |
| 11 | −125.857 | −1.99 | | |
| 12 | −241.236 | −1.53 | 1.48749 | 70.2 |
| 13 | ∞ | 1.53 | | |
| 14 | −241.236 | 1.99 | | |
| 15 | −125.857 | 1.10 | 2.00100 | 29.1 |
| 16 | ∞ | 1.00 | 1.51633 | 64.1 |
| 17 | ∞ | 0.10 | | |
| 18 | 58.745 | 11.94 | 1.58913 | 61.1 |
| 19* | −78.590 | 11.80 | | |
| 20 | ∞ | 2.00 | 1.51633 | 64.1 |
| 21 | ∞ | 0.80 | | |
| Image Plane | ∞ | | | |

ASPHERIC DATA
5th Surface
K = 0.00000e+00 A 4 = 1.35313e−05 A 6 = 1.06297e−08 A 8 = −3.43838e−11
A10 = 1.61712e−14
6th Surface
K = 0.00000e+00 A 4 = 2.03388e−05 A 6 = 1.66076e−08 A 8 = −1.98777e−11
A10 = 2.19442e−14
19th Surface
K = 0.00000e+00 A 4 = 3.00343e−06 A 6 = −2.90275e−09 A 8 = 1.24664e−12

VARIOUS DATA

| | |
|---|---|
| Focal Length | 40.00 |
| Fno | 1.00 |
| Image Height | 21.64 |
| BF | 0.80 |
| d21 | 0.80 |

### Numerical Example 7

UNIT: mm
SURFACE DATA

| Surface No. | r | d | nd | νd |
|---|---|---|---|---|
| 1 | 60.543 | 2.09 | 1.86966 | 20.0 |
| 2 | 70.322 | 0.03 | | |
| 3 | 64.905 | 7.33 | 1.49700 | 81.5 |
| 4 | 2836.455 | 0.60 | | |
| 5* | 248.558 | 10.32 | 1.69895 | 30.1 |
| 6* | 76.111 | 5.19 | | |
| 7 (SP) | ∞ | 9.99 | | |
| 8 | ∞ | 1.00 | 1.51633 | 64.1 |
| 9 | ∞ | 7.04 | 1.51633 | 64.1 |
| 10 | −1086.716 | 2.62 | | |
| 11 | −151.404 | −2.62 | | |
| 12 | −1086.716 | −7.04 | 1.51633 | 64.1 |
| 13 | ∞ | 7.04 | | |
| 14 | −1086.716 | 2.62 | | |
| 15 | −151.404 | 1.85 | 1.69895 | 30.1 |
| 16 | ∞ | 1.60 | 1.51633 | 64.1 |
| 17 | ∞ | 0.98 | | |
| 18* | 87.100 | 3.98 | 1.59270 | 35.3 |
| 19* | 75.631 | 0.12 | | |
| 20 | 49.733 | 14.25 | 1.49700 | 81.5 |
| 21 | −51.227 | 12.46 | | |
| 22 | ∞ | 2.10 | 1.51633 | 64.1 |
| 23 | ∞ | 0.80 | | |
| Image Plane | ∞ | | | |

ASPHERIC DATA
5th Surface
K = 0.00000e+00 A 4 = 2.24785e−07 A 6 = −1.50351e−10
6th Surface
K = 0.00000e+00 A 4 = 1.34110e−06 A 6 = −9.02585e−10 A 8 = 2.00217e−12
A10 = −1.43912e−15
18th Surface
K = 0.00000e+00 A 4 = 8.80256e−07 A 6 = −1.16606e−08 A 8 = −5.82365e−12
A10 = 1.36820e−14
19th Surface
K = 0.00000e+00 A 4 = 3.73922e−06 A 6 = −8.29498e−09 A 8 = −1.21974e−11
A10 = 2.24204e−14

VARIOUS DATA

| | |
|---|---|
| Focal Length | 50.00 |
| Fno | 1.01 |
| Image Height | 21.64 |
| BF | 0.80 |
| d23 | 0.80 |

### Numerical Example 8

UNIT: mm
SURFACE DATA

| Surface No. | r | d | nd | νd |
|---|---|---|---|---|
| 1 | 46.883 | 16.18 | 1.51742 | 52.4 |
| 2 | 2258.211 | 5.13 | | |
| 3 | 124.273 | 2.50 | 2.00100 | 29.1 |
| 4 | 62.799 | 0.10 | 1.54000 | 40.0 |
| 5* | 70.116 | 5.54 | | |
| 6 (SP) | ∞ | 8.72 | | |
| 7 | ∞ | 1.00 | 1.51633 | 64.1 |
| 8 | ∞ | 1.09 | 1.51633 | 64.1 |
| 9 | ∞ | 2.87 | | |
| 10 | −144.185 | −2.87 | | |
| 11 | ∞ | −1.09 | 1.51633 | 64.1 |
| 12 | ∞ | 1.09 | | |
| 13 | ∞ | 2.87 | | |
| 14 | −144.185 | 1.85 | 2.05090 | 26.9 |
| 15 | ∞ | 1.60 | 1.51633 | 64.1 |
| 16 | ∞ | 0.99 | | |
| 17* | 592.126 | 0.10 | 1.54000 | 40.0 |
| 18 | −1989.032 | 5.76 | 1.69895 | 30.1 |
| 19 | −152.676 | 5.98 | | |
| 20 | 84.734 | 9.51 | 1.55200 | 70.7 |
| 21 | −55.061 | 14.88 | | |
| 22 | ∞ | 2.10 | 1.51633 | 64.1 |
| 23 | ∞ | 0.80 | | |
| Image Plane | ∞ | | | |

ASPHERIC DATA
5th Surface
K = 0.00000e+00 A 4 = 1.80464e−06 A 6 = 1.15889e−09 A 8 = −3.87444e−13
A10 = 1.13994e−15
17th Surface
K = 0.00000e+00 A 4 = −4.04745e−06 A 6 = 2.33431e−09 A 8 = −1.38817e−11
A10 = 1.71050e−14

VARIOUS DATA

| | |
|---|---|
| Focal Length | 50.00 |
| Fno | 1.00 |
| Image Height | 21.64 |
| BF | 0.80 |
| d23 | 0.80 |

### Numerical Example 9

UNIT: mm
SURFACE DATA

| Surface No. | r | d | nd | νd |
|---|---|---|---|---|
| 1 | 53.093 | 5.94 | 1.48749 | 70.2 |
| 2 | 117.996 | 5.94 | | |
| 3 | 49.048 | 9.08 | 1.43875 | 94.7 |
| 4 | 4478.988 | 2.29 | | |
| 5* | 134.760 | 2.50 | 1.77250 | 49.6 |
| 6* | 49.163 | 6.51 | | |
| 7 (SP) | ∞ | 9.65 | | |
| 8 | ∞ | 1.00 | 1.51633 | 64.1 |
| 9 | ∞ | 1.30 | 1.51633 | 64.1 |
| 10 | −1156.638 | 2.67 | | |
| 11 | −149.205 | −2.67 | | |
| 12 | −1156.638 | −1.30 | 1.51633 | 64.1 |
| 13 | ∞ | 1.30 | | |
| 14 | −1156.638 | 2.67 | | |
| 15 | −149.205 | 1.85 | 1.88300 | 40.8 |
| 16 | ∞ | 1.60 | 1.51633 | 64.1 |
| 17 | ∞ | 1.00 | | |
| 18* | −180.061 | 4.00 | 1.54000 | 54.0 |
| 19* | −162.829 | 0.19 | | |
| 20 | 65.352 | 14.20 | 1.49700 | 81.5 |
| 21 | −49.182 | 15.41 | | |
| 22 | ∞ | 2.10 | 1.51633 | 64.1 |
| 23 | ∞ | 0.80 | | |
| Image Plane | ∞ | | | |

ASPHERIC DATA
5th Surface
K = 0.00000e+00 A 4 = −1.19104e−06 A 6 = 3.31478e−10 A 8 = −6.61731e−13
A10 = 4.79846e−16
6th Surface
K = 0.00000e+00 A 4 = 3.21294e−08 A 6 = 5.75777e−10 A 8 = −9.08668e−13
A10 = 8.20301e−16
18th Surface
K = 0.00000e+00 A 4 = −2.90525e−07 A 6 = −3.52308e−09 A 8 = 3.83747e−12
A10 = −7.43311e−15
19th Surface
K = 0.00000e+00 A 4 = 3.65886e−06 A 6 = −4.22135e−09 A 8 = 1.17059e−11
A10 = −1.45354e−14

VARIOUS DATA

| | |
|---|---|
| Focal Length | 51.00 |
| Fno | 0.95 |
| Image Height | 21.64 |
| BF | 0.80 |
| d23 | 0.80 |

### Numerical Example 10

UNIT: mm
SURFACE DATA

| Surface No. | r | d | nd | νd |
|---|---|---|---|---|
| 1 | 55.593 | 9.34 | 1.49700 | 81.5 |
| 2 | 129.406 | 0.10 | | |
| 3 | 44.267 | 14.47 | 1.43875 | 94.7 |
| 4 | 680.265 | 0.56 | | |
| 5* | 83.040 | 2.50 | 1.77250 | 49.5 |
| 6* | 39.419 | 20.28 | | |
| 7 (SP) | ∞ | 8.16 | | |
| 8 | ∞ | 1.00 | 1.51633 | 64.1 |
| 9 | ∞ | 1.43 | 1.48749 | 70.2 |
| 10 | −795.031 | 3.28 | | |
| 11 | −181.430 | −3.28 | | |
| 12 | −795.031 | −1.43 | 1.48749 | 70.2 |
| 13 | ∞ | 1.43 | | |
| 14 | −795.031 | 3.28 | | |
| 15 | −181.430 | 1.53 | 2.05090 | 26.9 |
| 16 | ∞ | 2.00 | 1.51633 | 64.1 |
| 17 | ∞ | 0.34 | | |
| 18 | −498.457 | 11.45 | 1.69895 | 30.1 |
| 19 | −220.027 | 0.10 | | |
| 20 | 65.340 | 5.45 | 1.65160 | 58.5 |
| 21 | −281.113 | 18.00 | | |
| Image Plane | ∞ | | | |

ASPHERIC DATA
5th Surface
K = 0.00000e+00 A 4 = −2.95300e−07 A 6 = −1.06664e−09 A 8 = 2.68053e−13
6th Surface
K = 0.00000e+00 A 4 = 1.11655e−06 A 6 = −2.44005e−10

VARIOUS DATA

| | |
|---|---|
| Focal Length | 65.00 |
| Fno | 1.00 |
| Image Height | 21.64 |
| BF | 18.00 |
| d21 | 18.00 |

### Numerical Example 11

UNIT: mm
SURFACE DATA

| Surface No. | r | d | nd | νd |
|---|---|---|---|---|
| 1 | 83.323 | 15.00 | 1.49700 | 81.5 |
| 2 | −2619.161 | 0.10 | | |
| 3 | 59.120 | 6.22 | 1.96300 | 24.1 |
| 4 | 80.556 | 0.10 | | |
| 5 | 40.124 | 14.24 | 1.43875 | 94.7 |
| 6 | 91.367 | 0.10 | | |
| 7 | 70.013 | 2.12 | 2.00100 | 29.1 |
| 8 | 31.127 | 6.07 | | |
| 9 | 55.673 | 12.16 | 1.43875 | 94.7 |
| 10 | −81.172 | 1.53 | 1.95375 | 32.3 |
| 11 | 105.212 | 7.98 | | |
| 12 (SP) | ∞ | 15.02 | | |
| 13 | 161.826 | 2.27 | 1.86966 | 20.0 |
| 14 | ∞ | 1.45 | 1.84666 | 23.8 |
| 15 | −801.551 | 3.36 | | |
| 16 | −232.902 | −3.36 | | |
| 17 | −801.551 | −1.45 | 1.84666 | 23.8 |
| 18 | ∞ | 1.45 | | |
| 19 | −801.551 | 3.36 | | |
| 20 | −232.902 | 1.53 | 1.86966 | 20.0 |
| 21 | ∞ | 1.00 | 1.51633 | 64.1 |
| 22 | ∞ | 0.10 | | |
| 23 | 75.782 | 11.53 | 1.63930 | 44.9 |
| 24 | −470.654 | 18.12 | | |
| Image Plane | ∞ | | | |

VARIOUS DATA

| | |
|---|---|
| Focal Length | 85.00 |
| Fno | 1.00 |
| Image Height | 21.64 |
| BF | 18.12 |
| d24 | 18.12 |

### Numerical Example 12

UNIT: mm
SURFACE DATA

| Surface No. | r | d | nd | νd |
|---|---|---|---|---|
| 1 | 85.614 | 18.66 | 1.49700 | 81.5 |
| 2 | 2745.933 | 0.10 | | |
| 3 | 79.507 | 5.26 | 2.00100 | 29.1 |
| 4 | 100.367 | 0.10 | | |
| 5 | 49.910 | 17.30 | 1.43387 | 95.1 |
| 6 | 133.418 | 0.10 | | |
| 7 | 106.348 | 6.84 | 1.88300 | 40.8 |
| 8 | 36.184 | 3.92 | | |
| 9 | 47.207 | 16.09 | 1.43875 | 94.7 |
| 10 | −90.295 | 1.80 | 1.88300 | 40.8 |
| 11 | 47.396 | 1.50 | | |
| 12 | 46.606 | 7.51 | 1.48749 | 70.2 |
| 13 | 532.709 | 1.72 | | |
| 14 (SP) | ∞ | 20.53 | | |
| 15 | 220.879 | 1.91 | 1.86966 | 20.0 |
| 16 | ∞ | 3.00 | 1.84666 | 23.8 |
| 17 | −1232.463 | 3.33 | | |
| 18 | −238.070 | −3.33 | | |
| 19 | −1232.463 | −3.00 | 1.84666 | 23.8 |
| 20 | ∞ | 3.00 | | |
| 21 | −1232.463 | 3.33 | | |
| 22 | −238.070 | 0.90 | 1.86966 | 20.0 |
| 23 | ∞ | 1.00 | 1.51633 | 64.1 |
| 24 | ∞ | 0.10 | | |
| 25 | 85.578 | 7.36 | 1.70154 | 41.2 |
| 26 | −497.560 | 20.94 | | |
| Image Plane | ∞ | | | |

VARIOUS DATA

| | |
|---|---|
| Focal Length | 100.00 |
| Fno | 1.00 |
| Image Height | 21.64 |
| BF | 20.94 |
| d26 | 20.94 |

### Numerical Example 13

UNIT: mm
SURFACE DATA

| Surface No. | r | d | nd | νd |
|---|---|---|---|---|
| 1 | 166.684 | 13.31 | 1.85150 | 40.8 |
| 2 | −1932.047 | 0.10 | | |
| 3 | 107.326 | 11.80 | 1.49700 | 81.5 |
| 4 | 234.386 | 4.09 | | |
| 5 | 3503.346 | 2.50 | 1.85150 | 40.8 |
| 6 | 110.685 | 17.54 | | |
| 7 | ∞ | 1.67 | 1.51633 | 64.1 |
| 8 | ∞ | 3.00 | 1.51633 | 64.1 |
| 9 | ∞ | 15.66 | | |
| 10 | −219.422 | −15.66 | | |
| 11 | ∞ | −3.00 | 1.51633 | 64.1 |
| 12 | ∞ | 3.00 | | |
| 13 | ∞ | 15.66 | | |
| 14 | −219.422 | 1.50 | 1.81600 | 46.6 |
| 15 | ∞ | 1.00 | 1.51633 | 64.1 |
| 16 | ∞ | 0.10 | | |
| 17 | 139.111 | 3.81 | 2.00100 | 29.1 |
| 18 | 64.283 | 5.36 | | |
| 19 (SP) | ∞ | 6.73 | | |
| 20 | 61.223 | 9.00 | 1.59551 | 39.2 |
| 21 | −326.664 | 3.63 | | |
| 22 | 250.653 | 8.49 | 1.59551 | 39.2 |
| 23 | −54.928 | 1.30 | 1.85400 | 40.4 |
| 24* | −6874.010 | 3.00 | | |
| 25 | 127.233 | 7.00 | 1.51633 | 64.1 |
| 26 | −70.549 | 19.48 | | |
| Image Plane | ∞ | | | |

ASPHERIC DATA
24th Surface
K = 0.00000e+00 A 4 = 8.11722e−07 A 6 = 1.40014e−10

VARIOUS DATA

| | |
|---|---|
| Focal Length | 100.00 |
| Fno | 1.00 |
| Image Height | 21.64 |
| BF | 19.48 |
| d26 | 19.48 |

### Numerical Example 14

UNIT: mm
SURFACE DATA

| Surface No. | r | d | nd | νd |
|---|---|---|---|---|
| 1 | 115.029 | 17.37 | 1.49700 | 81.5 |
| 2 | −1262.928 | 0.10 | | |
| 3 | 79.255 | 5.90 | 1.86966 | 20.0 |
| 4 | 99.735 | 0.10 | | |
| 5 | 64.915 | 18.36 | 1.43387 | 95.1 |
| 6 | 112.105 | 0.10 | | |
| 7 | 75.625 | 3.50 | 1.80000 | 29.8 |
| 8 | 43.659 | 3.65 | | |
| 9 | 53.145 | 16.16 | 1.43875 | 94.7 |
| 10 | −306.187 | 1.80 | 1.90366 | 31.3 |
| 11 | 58.060 | 11.64 | | |
| 12 | 51.311 | 2.05 | 2.00100 | 29.1 |
| 13 | 54.599 | 25.34 | | |
| 14 (SP) | ∞ | 13.60 | | |
| 15 | 264.238 | 1.96 | 1.86966 | 20.0 |
| 16 | ∞ | 2.56 | 1.51633 | 64.1 |
| 17 | ∞ | 12.57 | | |
| 18 | −423.304 | −12.57 | | |
| 19 | ∞ | −2.56 | 1.51633 | 64.1 |
| 20 | ∞ | 2.56 | | |
| 21 | ∞ | 12.57 | | |
| 22 | −423.304 | 1.40 | 1.86966 | 20.0 |
| 23 | ∞ | 1.00 | 1.51633 | 64.1 |
| 24 | ∞ | 0.10 | | |
| 25 | 104.058 | 3.11 | 1.85150 | 40.8 |
| 26 | 44673.407 | 25.64 | | |
| Image Plane | ∞ | | | |

VARIOUS DATA

| | |
|---|---|
| Focal Length | 150.00 |
| Fno | 1.00 |
| Image Height | 21.64 |
| BF | 25.64 |
| d26 | 25.64 |

### Numerical Example 15

UNIT: mm
SURFACE DATA

| Surface No. | r | d | nd | νd |
|---|---|---|---|---|
| 1 | 253.625 | 19.98 | 1.80440 | 39.6 |
| 2 | −1830.968 | 0.10 | | |
| 3 | 185.098 | 15.17 | 1.43387 | 95.1 |
| 4 | 398.079 | 7.62 | | |
| 5 | −7514.302 | 5.00 | 1.85150 | 40.8 |
| 6 | 189.713 | 28.49 | | |
| 7 | ∞ | 2.00 | 1.51633 | 64.1 |
| 8 | ∞ | 3.00 | 1.51633 | 64.1 |
| 9 | ∞ | 39.31 | | |
| 10 | −399.525 | −39.31 | | |
| 11 | ∞ | −3.00 | 1.51633 | 64.1 |
| 12 | ∞ | 3.00 | | |
| 13 | ∞ | 39.31 | | |
| 14 | −399.525 | 2.00 | 2.00100 | 29.1 |
| 15 | ∞ | 1.50 | 1.51633 | 64.1 |
| 16 | ∞ | 0.30 | | |
| 17 | −2723.276 | 1.70 | 1.84666 | 23.8 |
| 18 | −1352.890 | 1.50 | | |
| 19 (SP) | ∞ | 1.50 | | |
| 20 | 48.909 | 9.98 | 1.48749 | 70.2 |
| 21 | 251.784 | 0.10 | | |
| 22 | 152.948 | 2.00 | 1.88300 | 40.8 |
| 23 | 44.879 | 44.35 | | |
| 24 | 68.259 | 7.00 | 1.67270 | 32.1 |
| 25 | −234.445 | 29.47 | | |
| Image Plane | ∞ | | | |

VARIOUS DATA

| | |
|---|---|
| Focal Length | 200.00 |
| Fno | 1.20 |
| Image Height | 21.64 |
| BF | 29.47 |
| d25 | 29.47 |

### Numerical Example 16

UNIT: mm
SURFACE DATA

| Surface No. | r | d | nd | νd |
|---|---|---|---|---|
| 1 | 362.200 | 4.50 | 1.49700 | 81.5 |
| 2* | 95.180 | 0.10 | | |
| 3 | 74.415 | 27.80 | 1.51823 | 58.9 |
| 4 | −239.673 | 15.31 | | |
| 5 (SP) | ∞ | 5.70 | | |
| 6 | −202.139 | 3.00 | 1.95375 | 32.3 |
| 7 | ∞ | 4.11 | 1.80400 | 46.6 |
| 8 | −311.821 | 6.41 | | |
| 9* | −125.444 | 3.00 | 1.51823 | 58.9 |
| 10 | −154.205 | −3.00 | | |
| 11* | −125.444 | −6.41 | | |
| 12 | −311.821 | −4.11 | 1.80400 | 46.6 |
| 13 | ∞ | 4.11 | | |
| 14 | −311.821 | 6.41 | | |
| 15* | −125.444 | 3.00 | 1.51823 | 58.9 |
| 16 | −154.205 | 1.70 | 1.78472 | 25.7 |
| 17 | ∞ | 1.00 | | |
| 18 | 70.992 | 13.48 | 1.59522 | 67.7 |
| 19* | −128.739 | 0.10 | | |
| 20 | 96.666 | 21.18 | 1.43875 | 94.7 |
| 21 | −1583.996 | 0.10 | | |
| 22 | ∞ | 2.00 | 1.51633 | 64.1 |
| 23 | ∞ | 0.11 | | |
| Image Plane | ∞ | | | |

ASPHERIC DATA
2nd Surface
K = 0.00000e+00 A 4 = 2.78818e−07 A 6 = 6.20426e−11 A 8 = −9.23762e−15
A10 = 5.84053e−18
9th Surface
K = 0.00000e+00 A 4 = −2.00130e−07 A 6 = −4.31106e−11 A 8 = 1.69152e−14
A10 = −7.15556e−18
11th Surface
K = 0.00000e+00 A 4 = −2.00130e−07 A 6 = −4.31106e−11 A 8 = 1.69152e−14
A10 = −7.15556e−18
15th Surface
K = 0.00000e+00 A 4 = −2.00130e−07 A 6 = −4.31106e−11 A 8 = 1.69152e−14
A10 = −7.15556e−18
19th Surface
K = 0.00000e+00 A 4 = 1.73714e−07 A 6 = 9.77649e−11

VARIOUS DATA

| | |
|---|---|
| Focal Length | 50.00 |
| Fno | 0.55 |
| Image Height | 21.64 |
| BF | 0.11 |
| d23 | 0.11 |

### Numerical Example 17

UNIT: mm
SURFACE DATA

| Surface No. | r | d | nd | νd |
|---|---|---|---|---|
| 1 | 109.300 | 2.38 | 1.88300 | 40.8 |
| 2 | 43.625 | 16.38 | | |
| 3 | 753.174 | 2.50 | 1.59522 | 67.7 |
| 4 | 120.673 | 6.76 | | |
| 5 | −260.400 | 1.90 | 1.43875 | 94.7 |
| 6 | 102.631 | 7.67 | 1.92286 | 20.9 |
| 7 | 372.961 | 0.10 | 1.53172 | 48.8 |
| 8* | 217.855 | (Variable) | | |
| 9* | 87.617 | 13.07 | 1.59270 | 35.3 |
| 10 | −43.753 | 1.80 | 1.95375 | 32.3 |
| 11 | −69.143 | 8.83 | | |
| 12 | −113.086 | 1.90 | 1.86966 | 20.0 |
| 13 | 184.499 | 8.16 | 1.83481 | 42.7 |
| 14 | ∞ | −8.16 | | |
| 15 | 184.499 | 8.16 | | |
| 16 | ∞ | 1.20 | 1.51633 | 64.1 |
| 17 | ∞ | (Variable) | | |
| 18 (SP) | ∞ | 6.55 | | |
| 19 | 46.847 | 5.49 | 1.92286 | 20.9 |
| 20 | −39.949 | 0.95 | 1.85025 | 30.1 |
| 21 | 37.776 | 2.81 | | |
| 22* | −66.069 | 0.95 | 2.00100 | 29.1 |
| 23 | 41.340 | 6.24 | 1.43875 | 94.7 |
| 24 | −45.887 | 0.62 | | |
| 25 | 59.331 | 11.13 | 1.43875 | 94.7 |
| 26 | −31.010 | (Variable) | | |
| 27 | −130.580 | 7.06 | 1.43875 | 94.7 |
| 28 | −30.949 | 1.29 | | |
| 29* | 299.776 | 2.38 | 1.95150 | 29.8 |
| 30* | 118.562 | (Variable) | | |
| 31 | ∞ | 1.80 | 1.51633 | 64.1 |
| 32 | ∞ | 40 | | |
| Image Plane | ∞ | | | |

ASPHERIC DATA
8th Surface
K = 0.00000e+00 A 4 = −1.00738e−06 A 6 = 1.94315e−10 A 8 = −8.92776e−14
A10 = 8.76201e−18
9th Surface
K = 0.00000e+00 A 4 = −9.45836e−07 A 6 = 3.59897e−10
22nd Surface
K = 0.00000e+00 A 4 = −6.30082e−06 A 6 = −5.37086e−09 A 8 = 2.51835e−11
A10 = −1.26875e−13
29th Surface
K = 0.00000e+00 A 4 = −3.72607e−05 A 6 = −4.65488e−08 A 8 = 8.30739e−11
30th Surface
K = 0.00000e+00 A 4 = −3.29966e−05 A 6 = −4.56380e−08 A 8 = 1.72438e−10
A10 = −1.92890e−13 A12 = 1.05183e−16

VARIOUS DATA

| | | | |
|---|---|---|---|
| Focal Length | 20.50 | 32.00 | 39.50 |
| Fno | 1.40 | 1.40 | 1.40 |
| Image Height | 21.30 | 21.30 | 21.30 |
| BF | 0.40 | 0.40 | 0.40 |
| d8 | 51.06 | 14.77 | 2.57 |
| d17 | 1.00 | 13.12 | 20.68 |
| d26 | 0.70 | 3.06 | 4.78 |
| d30 | 15.87 | 13.52 | 11.79 |
| d32 | 0.40 | 0.40 | 0.40 |

### Numerical Example 18

UNIT: mm
SURFACE DATA

| Surface No. | r | d | nd | νd |
|---|---|---|---|---|
| 1 | 148.065 | 10.80 | 1.49700 | 81.5 |
| 2 | 600.901 | (Variable) | | |
| 3 | 468.543 | 2.48 | 1.49700 | 81.5 |
| 4 | 61.662 | 12.59 | | |
| 5 | −107.650 | 2.20 | 1.72964 | 54.6 |
| 6 | 194.384 | 10.10 | | |
| 7 | 189.512 | 5.07 | 1.76785 | 30.0 |
| 8 | −467.589 | (Variable) | | |
| 9 | 662.352 | 5.10 | 1.78125 | 49.0 |
| 10 | −151.191 | 3.77 | | |
| 11 | −103.757 | 2.20 | 1.81946 | 29.2 |
| 12 | 199.808 | 2.71 | 1.75772 | 51.4 |
| 13 | ∞ | −2.71 | | |
| 14 | 199.808 | 2.71 | | |
| 15 | ∞ | 3.00 | 1.51633 | 64.1 |
| 16 | ∞ | (Variable) | | |
| 17 (SP) | ∞ | 14.57 | | |
| 18 | 34.101 | 8.36 | 1.71379 | 29.3 |
| 19 | −67.924 | 1.65 | 1.84593 | 43.4 |
| 20 | 38.768 | 7.12 | | |
| 21 | 182.416 | 1.65 | 1.95715 | 32.0 |
| 22 | 31.407 | 17.14 | 1.43875 | 94.9 |
| 23 | −115.314 | 0.10 | | |
| 24 | 49.852 | 8.52 | 1.43875 | 94.9 |
| 25 | −57.684 | 0.70 | | |
| 26 | −145.292 | 5.35 | 1.43875 | 94.9 |
| 27 | −39.718 | 3.68 | | |
| 28* | −272.421 | 3.30 | 1.95150 | 29.8 |
| 29* | 295.219 | (Variable) | | |
| 30 | ∞ | 3.00 | 1.51633 | 64.1 |
| 31 | ∞ | 0.40 | | |
| Image Plane | ∞ | | | |

ASPHERIC DATA
28th Surface
K = 0.00000e+00 A 4 = −3.37812e−05 A 6 = 6.67955e−09 A 8 = 1.89280e−11
29th Surface
K = 0.00000e+00 A 4 = −3.13542e−05 A 6 = 1.28966e−08 A 8 = 3.35922e−11
A10 = −6.33814e−14 A12 = 4.80398e−17

VARIOUS DATA

| | | | |
|---|---|---|---|
| Focal Length | 35.70 | 49.38 | 68.00 |
| Fno | 1.40 | 1.40 | 1.40 |
| Image Height | 19.42 | 21.63 | 21.64 |
| BF | 0.40 | 0.40 | 0.40 |
| d2 | 10.43 | 38.62 | 59.68 |
| d8 | 64.53 | 30.01 | 0.50 |
| d16 | 1.04 | 7.37 | 15.82 |
| d29 | 10.60 | 10.60 | 10.60 |
| d31 | 0.40 | 0.40 | 0.40 |

### Numerical Example 19

UNIT: mm
SURFACE DATA

| Surface No. | r | d | nd | νd |
|---|---|---|---|---|
| 1 | 383.381 | 4.50 | 1.48749 | 70.2 |
| 2* | 83.055 | 0.10 | | |
| 3 | 68.809 | 28.80 | 1.51742 | 52.4 |
| 4 | −213.852 | 8.67 | | |
| 5 (SP) | ∞ | 12.18 | | |
| 6 | −174.478 | 3.00 | 2.00100 | 29.1 |
| 7 | ∞ | 3.76 | 1.95375 | 32.3 |
| 8 | −408.080 | 6.35 | | |
| 9* | −138.418 | 3.00 | 1.59551 | 39.2 |
| 10 | −147.013 | −3.00 | | |
| 11* | −138.418 | −6.35 | | |
| 12 | −408.080 | −3.76 | 1.95375 | 32.3 |
| 13 | ∞ | 3.76 | | |
| 14 | −408.080 | 6.35 | | |
| 15* | −138.418 | 3.00 | 1.59551 | 39.2 |
| 16 | −147.013 | 2.20 | 1.80810 | 22.8 |
| 17 | ∞ | 1.00 | 1.51633 | 64.1 |
| 18 | ∞ | 0.10 | | |
| 19 | 78.931 | 15.45 | 1.61997 | 63.9 |
| 20* | −182.316 | 1.95 | | |
| 21 | 102.849 | 12.87 | 1.45860 | 90.2 |
| 22 | −120.007 | 4.47 | | |
| 23 | ∞ | 2.00 | 1.51633 | 64.1 |
| 24 | ∞ | 0.10 | | |
| Image Plane | ∞ | | | |

ASPHERIC DATA
2nd Surface
K = 0.00000e+00 A 4 = 3.66433e−07 A 6 = 6.63743e−11 A 8 = 5.63299e−15
A10 = 6.04056e−18
9th Surface
K = 0.00000e+00 A 4 = −1.52206e−07 A 6 = −5.16457e−11 A 8 = 4.16727e−14
A10 = −1.59271e−17
11th Surface
K = 0.00000e+00 A 4 = −1.52206e−07 A 6 = −5.16457e−11 A 8 = 4.16727e−14
A10 = −1.59271e−17
15th Surface
K = 0.00000e+00 A 4 = −1.52206e−07 A 6 = −5.16457e−11 A 8 = 4.16727e−14
A10 = −1.59271e−17
20th Surface
K = 0.00000e+00 A 4 = 5.87448e−07 A 6 = 1.17920e−10

VARIOUS DATA

| | |
|---|---|
| Focal Length | 50.00 |
| Fno | 0.65 |
| Image Height | 21.64 |
| BF | 0.10 |
| d24 | 0.10 |

### Numerical Example 20

UNIT: mm
SURFACE DATA

| Surface No. | r | d | nd | νd |
|---|---|---|---|---|
| 1 | −143.512 | 1.40 | 1.55200 | 70.7 |
| 2 | −591.993 | 0.10 | | |
| 3 | 31.524 | 10.33 | 1.43875 | 94.7 |
| 4 | −675.714 | 5.37 | | |
| 5* | −112.384 | 2.62 | 1.58913 | 61.1 |
| 6* | −237.104 | 3.16 | | |
| 7 (SP) | ∞ | 10.81 | | |
| 8 | −72.404 | 1.10 | 1.72916 | 54.7 |
| 9 | −157.281 | 2.61 | 1.48749 | 70.2 |
| 10 | −95.028 | 1.91 | | |
| 11 | −73.399 | −1.91 | | |
| 12 | −95.028 | −2.61 | 1.48749 | 70.2 |
| 13 | −157.281 | 2.61 | | |
| 14 | −95.028 | 1.91 | | |
| 15 | −73.399 | 1.10 | 1.69895 | 30.1 |
| 16 | ∞ | 1.00 | 1.51633 | 64.1 |
| 17 | ∞ | 0.10 | | |
| 18 | 56.234 | 9.04 | 1.58913 | 61.1 |
| 19* | −57.763 | 0.89 | | |
| 20 | ∞ | 12.49 | | |
| 21 | ∞ | 2.00 | 1.51633 | 64.1 |
| 22 | ∞ | 0.80 | | |
| Image Plane | ∞ | | | |

ASPHERIC DATA
5th Surface
K = 0.00000e+00 A 4 = 2.06355e−05 A 6 = −7.03220e−09 A 8 = −1.16989e−11
6th Surface
K = 0.00000e+00 A 4 = 2.67780e−05
19th Surface
K = 0.00000e+00 A 4 = 3.98022e−06 A 6 = −2.79884e−09 A 8 = 8.22543e−13

VARIOUS DATA

| | |
|---|---|
| Focal Length | 40.00 |
| Fno | 1.00 |
| Image Height | 21.64 |
| BF | 0.80 |
| d22 | 0.80 |

### Numerical Example 21

UNIT: mm
SURFACE DATA

| Surface No. | r | d | nd | νd |
|---|---|---|---|---|
| 1 | −574.653 | 2.36 | 1.72916 | 54.7 |
| 2 | 457.186 | 0.10 | | |
| 3 | 29.782 | 10.06 | 1.43875 | 94.7 |
| 4 | 1799.748 | 5.06 | | |
| 5* | −152.173 | 2.59 | 1.58913 | 61.1 |
| 6* | −456.669 | 3.40 | | |
| 7 (SP) | ∞ | 13.11 | | |
| 8 | −274.000 | 1.10 | 1.83481 | 42.7 |
| 9 | ∞ | 0.05 | 1.49000 | 49.0 |
| 10 | ∞ | 0.20 | 1.59000 | 30.0 |
| 11 | ∞ | 1.53 | 1.48749 | 70.2 |
| 12 | −243.336 | 2.00 | | |
| 13 | −125.365 | −2.00 | | |
| 14 | −243.336 | −1.53 | 1.48749 | 70.2 |
| 15 | ∞ | −0.20 | 1.59000 | 30.0 |
| 16 | ∞ | 0.20 | | |
| 17 | ∞ | 1.53 | 1.48749 | 70.2 |
| 18 | −243.336 | 2.00 | | |
| 19 | −125.365 | 1.50 | 2.00100 | 29.1 |
| 20 | ∞ | 0.20 | 1.59000 | 30.0 |
| 21 | ∞ | 0.20 | 1.49000 | 49.0 |
| 22 | ∞ | 1.20 | 1.51633 | 64.1 |
| 23 | ∞ | 0.10 | | |
| 24 | 57.855 | 10.64 | 1.58913 | 61.1 |
| 25* | −80.184 | 11.70 | | |
| 26 | ∞ | 2.00 | 1.51633 | 64.1 |
| 27 | ∞ | 0.90 | | |
| Image Plane | ∞ | | | |

ASPHERIC DATA
5th Surface
K = 0.00000e+00 A 4 = 1.67444e−05 A 6 = 5.47451e−09 A 8 = −3.13737e−11
A10 = 1.49003e−14
6th Surface
K = 0.00000e+00 A 4 = 2.36785e−05 A 6 = 1.22625e−08 A 8 = −1.60987e−11
A10 = 2.11475e−14
25th Surface
K = 0.00000e+00 A 4 = 2.91850e−06 A 6 = −2.91997e−09 A 8 = 1.47449e−12

VARIOUS DATA

| | |
|---|---|
| Focal Length | 40.00 |
| Fno | 1.00 |
| Image Height | 21.64 |
| BF | 0.90 |
| d27 | 0.90 |

### Numerical Example 22

UNIT: mm
SURFACE DATA

| Surface No. | r | d | nd | νd |
|---|---|---|---|---|
| 1* | 974.978 | 2.30 | 1.69680 | 55.5 |
| 2* | 194.077 | 2.40 | | |
| 3 | 33.294 | 12.57 | 1.43875 | 94.7 |
| 4 | −649.182 | 1.21 | | |
| 5 (SP) | ∞ | 15.79 | | |
| 6 | −253.680 | 1.10 | 1.80420 | 46.5 |
| 7 | ∞ | 1.18 | 1.76802 | 49.2 |
| 8* | −719.093 | 2.45 | | |
| 9 | −127.823 | −2.45 | | |
| 10* | −719.093 | −1.18 | 1.76802 | 49.2 |
| 11 | ∞ | 1.18 | | |
| 12* | −719.093 | 2.45 | | |
| 13 | −127.823 | 1.30 | 2.05090 | 26.9 |
| 14 | ∞ | 1.50 | 1.51633 | 64.1 |
| 15 | ∞ | 2.79 | | |
| 16 | 68.610 | 10.46 | 1.58913 | 61.1 |
| 17* | −54.245 | 11.80 | | |
| 18 | ∞ | 2.00 | 1.51633 | 64.1 |
| 19 | ∞ | 0.80 | | |
| Image Plane | ∞ | | | |

ASPHERIC DATA
1st Surface
K = 0.00000e+00 A 4 = 2.61197e−06 A 6 = 1.32766e−10
2nd Surface
K = 0.00000e+00 A 4 = 3.78587e−06 A 6 = 5.16808e−10 A 8 = 6.25749e−13
8th Surface
K = 0.00000e+00 A 4 = 1.56205e−06 A 6 = 3.78053e−10 A 8 = 3.34722e−12
10th Surface
K = 0.00000e+00 A 4 = 1.56205e−06 A 6 = 3.78053e−10 A 8 = 3.34722e−12
12th Surface
K = 0.00000e+00 A 4 = 1.56205e−06 A 6 = 3.78053e−10 A 8 = 3.34722e−12
17th Surface
K = 0.00000e+00 A 4 = 3.15265e−06 A 6 = −4.07401e−09 A 8 = 1.08173e−12

VARIOUS DATA

| | |
|---|---|
| Focal Length | 40.00 |
| Fno | 1.00 |
| Image Height | 21.64 |
| BF | 0.80 |
| d19 | 0.80 |

Table 1 summarizes the values of inequalities (1) to (10) in each numerical example. Numerical examples 17 and 18 are illustrated for both the telephoto end and the wide-angle end. The imaging optical system according to each numerical example satisfies all of inequalities (1) to (10).

TABLE 1

| | Numerical Example | | | | | |
|---|---|---|---|---|---|---|
| | 1 | 2 | 3 | 4 | 5 | 6 |
| Nnave − Npave | 0.093 | 0.139 | 0.193 | 0.155 | 0.096 | 0.283 |
| (1/νnave − 1/νpane)/ | 0.005 | 0.014 | 0.030 | 0.043 | 0.036 | 0.028 |
| (Nnave − Npve) | | | | | | |
| Rt | 6.837 | 5.517 | 3.471 | 2.607 | 1.919 | 1.749 |
| 3.2Rt − 6 | 15.879 | 11.66 | 5.11 | 2.343 | 0.141 | −0.402 |
| 28Rt + 20 | 211.442 | 174.483 | 117.196 | 93.000 | 73.734 | 68.980 |
| θ | 63.183 | 59.469 | 47.429 | 40.028 | 32.831 | 29.841 |
| abs\|f/RL\| | 0.000 | 0.000 | 0.000 | 0.000 | 0.000 | 0.000 |
| abs\|Rs/f\| | 9.316 | 7.462 | 4.278 | 3.572 | 2.940 | 3.146 |
| Npave | 1.592 | 1.573 | 1.617 | 1.641 | 1.627 | 1.505 |
| Nnave | 1.684 | 1.712 | 1.810 | 1.796 | 1.722 | 1.789 |
| Nnave × νnave | 104.796 | 100.290 | 81.938 | 77.439 | 78.777 | 83.926 |
| D12/f | 0.254 | 0.225 | 0.155 | 0.135 | 0.105 | 0.088 |
| abs\|Rns/f\| | 1.187 | 1.191 | 1.006 | 0.891 | 1.453 | 3.146 |
| | Numerical Example | | | | | |
| | 7 | 8 | 9 | 10 | 11 | 12 |
| Nnave − Npave | 0.069 | 0.436 | 0.337 | 0.357 | 0.271 | 0.246 |
| (1/νnave − 1/νpane)/ | 0.222 | 0.037 | 0.026 | 0.032 | 0.069 | 0.054 |
| (Nnave − Npve) | | | | | | |
| Rt | 1.687 | 1.734 | 1.726 | 1.539 | 1.412 | 1.400 |
| 3.2Rt − 6 | −0.602 | −0.45 | −0.477 | −1.077 | −1.482 | −1.520 |
| 28Rt + 20 | 67.234 | 68.547 | 68.329 | 63.078 | 59.529 | 59.200 |
| θ | 24.398 | 23.473 | 23.213 | 18.408 | 14.163 | 12.090 |
| abs\|f/RL\| | 0.000 | 0.000 | 0.000 | 0.000 | 0.000 | 0.000 |
| abs\|Rs/f\| | 3.028 | 2.884 | 2.926 | 2.791 | 2.740 | 2.381 |
| Npave | 1.595 | 1.589 | 1.491 | 1.555 | 1.670 | 1.633 |
| Nnave | 1.664 | 2.026 | 1.828 | 1.912 | 1.941 | 1.879 |
| Nnave × νnave | 52.951 | 56.805 | 82.644 | 73.032 | 52.726 | 63.582 |
| D12/f | 0.193 | 0.079 | 0.078 | 0.073 | 0.057 | 0.063 |
| abs\|Rns/f\| | 1.406 | 1.402 | 0.964 | 0.606 | 0.366 | 0.362 |

| | Numerical Example | | | | | |
|---|---|---|---|---|---|---|
| | | | | | 17 | 17 |
| | | | | | (wide- | (telephoto |
| | 13 | 14 | 15 | 16 | angle end) | end) |
| Nnave − Npave | 0.269 | 0.149 | 0.263 | 0.099 | 0.162 | 0.162 |
| (1/νnave − 1/νpane)/ | 0.025 | 0.125 | 0.030 | 0.053 | 0.036 | 0.036 |
| (Nnave − Npve) | | | | | | |
| Rt | 1.401 | 1.120 | 1.110 | 2.192 | 9.216 | 4.054 |
| 3.2Rt − 6 | −1.518 | −2.416 | −2.447 | 1.014 | 23.492 | 6.972 |
| 28Rt + 20 | 59.219 | 51.363 | 51.089 | 81.376 | 278.055 | 133.507 |
| θ | 12.037 | 8.128 | 6.083 | 24.098 | 49.689 | 26.756 |
| abs\|f/RL\| | 0.000 | 0.000 | 0.000 | 0.000 | 0.000 | 0.000 |
| abs\|Rs/f\| | 2.194 | 2.822 | 1.998 | 3.084 | 9.000 | 4.671 |
| Npave | 1.611 | 1.709 | 1.649 | 1.589 | 1.656 | 1.656 |
| Nnave | 1.881 | 1.858 | 1.912 | 1.688 | 1.818 | 1.818 |
| Nnave × νnave | 73.777 | 50.283 | 70.530 | 83.763 | 78.287 | 78.287 |
| D12/f | 0.187 | 0.101 | 0.212 | 0.270 | 0.398 | 0.207 |
| abs\|Rns/f\| | 0.643 | 0.291 | 0.224 | 1.904 | 1.843 | 0.956 |

| | Numerical Example | | | | | |
|---|---|---|---|---|---|---|
| | 18 | 18 | | | | |
| | (wide- | (telephoto | | | | |
| | angle end) | end) | 19 | 20 | 21 | 22 |
| Nnave − Npave | 0.196 | 0.196 | 0.086 | 0.137 | 0.283 | 0.252 |
| (1/νnave − 1/νpane)/ | 0.036 | 0.036 | 0.094 | 0.038 | 0.028 | 0.034 |
| (Nnave − Npve) | | | | | | |
| Rt | 6.223 | 3.267 | 2.210 | 1.671 | 1.750 | 1.741 |
| 3.2Rt − 6 | 13.913 | 4.455 | 1.072 | −0.653 | −0.400 | −0.427 |
| 28Rt + 20 | 194.242 | 111.477 | 81.880 | 66.784 | 69.000 | 68.761 |
| θ | 30.951 | 16.942 | 24.075 | 29.884 | 29.750 | 28.774 |
| abs\|f/RL\| | 0.000 | 0.000 | 0.000 | 0.254 | 0.000 | 0.000 |
| abs\|Rs/f\| | 5.597 | 2.938 | 2.940 | 1.835 | 3.134 | 3.196 |
| Npave | 1.604 | 1.604 | 1.637 | 1.505 | 1.505 | 1.599 |
| Nnave | 1.800 | 1.800 | 1.723 | 1.642 | 1.789 | 1.851 |
| Nnave × νnave | 81.212 | 81.212 | 69.511 | 88.956 | 83.926 | 79.520 |
| D12/f | 0.076 | 0.040 | 0.262 | 0.113 | 0.093 | 0.091 |
| abs\|Rns/f\| | 1.086 | 0.570 | 1.661 | 1.810 | 3.134 | 3.196 |

### Image Pickup Apparatus

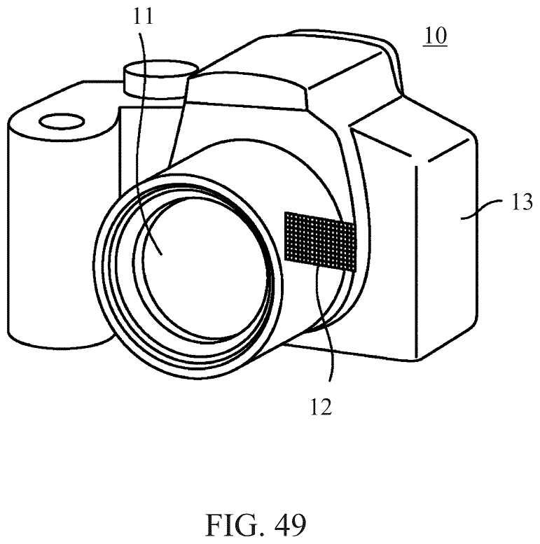

FIG. 49 illustrates an image pickup apparatus 10 (digital still camera) that employs, as an imaging optical system, any one of the imaging optical systems according to Examples 1 to 22. The image pickup apparatus 10 includes a camera body 13, an imaging optical system 11 that is any one of the imaging optical systems according to Examples 1 to 22, and an image sensor 12 such as a CCD sensor or a CMOS sensor that captures an optical image (i.e., an object) formed by the imaging optical system 11.

Using the imaging optical system according to each example as the imaging optical system 11, each example can provide an image pickup apparatus 10 that can generate bright and high-quality images.

The disclosure can provide an imaging system, such as a surveillance camera system, which includes a camera having an imaging optical system serving as any of the imaging optical system according to any one of the above examples, and a control unit that controls the imaging optical system.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide an imaging optical system with a bright F-number and excellent imaging performance.

This application claims the benefit of Japanese Patent Application No. 2025-018995, filed on Feb. 7, 2025, which is hereby incorporated by reference herein in its entirety.

What is claimed is:

1. An imaging optical system comprising:
at least one positive lens;
at least one negative lens;
a first transmissive reflective surface; and
a second transmissive reflective surface disposed closer to an image plane than the first transmissive reflective surface,
wherein the following inequality is satisfied:
$$3 Rt - 6 \leq θ \leq 30 Rt + 20$$
where Rt is a telephoto ratio of the imaging optical system, and θ [°] is a half field angle of the imaging optical system.

2. The imaging optical system according to claim 1, further comprising a phase shifter disposed between the first transmissive reflective surface and the second transmissive reflective surface.

3. The imaging optical system according to claim 1, wherein the following inequality is satisfied:
$$0 < \vert f / R 1 \vert \leq 0. 5$$
where Rl is a radius of curvature of one of the first and second transmissive reflective surfaces that has a larger radius of curvature, and f is a focal length of the imaging optical system.

4. The imaging optical system according to claim 1, wherein the following inequality is satisfied:
$$0 < \vert Rs / f \vert \leq 20$$
where Rs is a radius of curvature of one of the first and second transmissive reflective surfaces that has a smaller radius of curvature, and f is a focal length of the imaging optical system.

5. The imaging optical system according to claim 1, wherein the following inequality is satisfied:
$$1.43 \leq Np \leq 1.78$$
where Np is an average value of a refractive index at d-line of the at least one positive lens.

6. The imaging optical system according to claim 1, wherein the following inequality is satisfied:
$$1. 60 \leq Nn \leq 2.1$$
where Nn is an average value of a refractive index at d-line of the at least one negative lens.

7. The imaging optical system according to claim 1, wherein the following inequality is satisfied:
$$40 \leq Nn \times vn \leq 125$$
where Nn is an average value of a refractive index at d-line of the at least one negative lens, and vn is an average value of an Abbe number at the d-line of the at least one negative lens.

8. The imaging optical system according to claim 1, wherein the following inequality is satisfied:
$$0 < D 12 / f \leq 0.5$$
where D12 is a distance on an optical axis between the first and second transmissive reflective surfaces, and f is a focal length of the imaging optical system.

9. The imaging optical system according to claim 1, wherein the following inequality is satisfied:
$$0. 2 \leq \vert Rns / f \vert \leq 5.$$
where Rns is a smallest radius of curvature among refractive surfaces having negative refractive power, and f is a focal length of the imaging optical system.

10. The imaging optical system according to claim 1, wherein the imaging optical system is a coaxial optical system.

11. The imaging optical system according to claim 1, wherein the number of the at least one positive lens is equal to or greater than the number of the at least one negative lens.

12. The imaging optical system according to claim 1, further comprising an aperture stop disposed closer to an image plane than a lens disposed closest to an object.

13. The imaging optical system according to claim 1, wherein the number of interfaces between air and a material having a refractive index of 1.4 or higher, between the first and second transmissive reflective surfaces, is two or less.

14. The imaging optical system according to claim 1, wherein the following inequality is satisfied:
$$0.06 \leq Nn - Np \leq 0.5$$
where Np is an average value of a refractive index at d-line of the at least one positive lens, and Nn is an average value of a refractive index at the d-line of the at least one negative lens.

15. The imaging optical system according to claim 1, wherein the following inequality is satisfied:
$$- 0.100 \leq ( 1 / vn - 1 / vp ) / ( Nn - Np ) \leq 0.225$$
where Np is an average value of a refractive index at d-line of the at least one positive lens, vp is an average value of an Abbe number at the d-line of the at least one positive lens, Nn is an average value of a refractive index at the d-line of the at least one negative lens, and vn is an average value of an Abbe number at the d-line of the at least one negative lens.

16. An imaging optical system comprising:
at least one positive lens;
at least one negative lens;
a first transmissive reflective surface; and
a second transmissive reflective surface disposed closer to an image plane than the first transmissive reflective surface.

17. An image pickup apparatus comprising:
an imaging optical system; and
an image sensor configured to capture an object through the imaging optical system,
wherein the imaging optical system includes:
at least one positive lens;
at least one negative lens;
a first transmissive reflective surface; and
a second transmissive reflective surface disposed closer to an image plane than the first transmissive reflective surface,
wherein the following inequality is satisfied:
$$3 Rt - 6 \leq θ \leq 30 Rt + 20$$
where Rt is a telephoto ratio of the imaging optical system, and θ [°] is a half field angle of the imaging optical system.
